(19) United States
(12) Patent Application Publication
(10) Pub. No.: US 2007/0210696 A1
(43) Pub. Date: Sep. 13, 2007

(54) ELECTRON-EMITTING DEVICE AND METHOD OF MANUFACTURING THE ELECTRON-EMITTING DEVICE

(75) Inventors: Shuichi Ozawa, Nagoya-city (JP); Yukimasa Mori, Nagoya-city (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/561,528

(22) Filed: Nov. 20, 2006

(30) Foreign Application Priority Data
Mar. 7, 2006 (JP) 2006-61761

(51) Int. Cl. H01J 63/04; H01J 1/62

(52) U.S. Cl. 313/495

(57) ABSTRACT

An electron-emitting device includes a lower electrode, an emitter section formed from a dielectric material, and an upper electrode having fine through holes formed therein. When a drive voltage is applied between the lower electrode and the upper electrode, the electron-emitting device emits electrons from the emitter section through the fine through holes of the upper electrode. A protective film of oxide (e.g., silicon oxide) is formed on the upper surface of the emitter section. Thus, the upper surface of the emitter section is protected from attack of ionized gas molecules produced during electron-emitting operations. As a result, the upper surface of the emitter section becomes unlikely to be metalized, and thus, the amount of emitted electrons is unlikely to drop with the number of electron-emitting operations.

### BACKGROUND OF THE INVENTION

1. Field of the Invention

The present invention relates to an electron-emitting device including an emitter section, which is formed from a dielectric material; a lower electrode, which is formed on a lower portion of the emitter section; and an upper electrode, which is formed on an upper portion of the emitter section opposed to the lower electrode to sandwich the emitter section between the same and the lower electrode, as well as to a method of manufacturing the same.

2. Description of the Related Art

A conventionally known electron-emitting device includes an emitter section, a lower electrode, and an upper electrode. The emitter section is formed from a dielectric material. The lower electrode is formed on a lower portion of the emitter section. The upper electrode is formed on an upper portion of the emitter section opposed to the lower electrode to sandwich the emitter section between the same and the lower electrode. The upper electrode has a plurality of fine through holes formed therein. The lower surface of a portion surrounding each fine through hole of the upper electrode is separated from and faces the upper surface of the emitter section, thereby forming an “eaves structure (or overhanging structure).”

When a drive voltage of a predetermined polarity is applied between the lower electrode and the upper electrode of the electron-emitting device, dipoles in the emitter section are inverted such that positive poles thereof are directed toward the upper electrode (i.e., negative-oriented polarization inversion is occurred). This causes electrons to be attracted from the upper electrode to the emitter section. As a result, the electrons are supplied to and accumulated at an upper portion of the emitter section. Next, when a drive voltage of a polarity opposite to the above predetermined polarity is applied between the lower electrode and the upper electrode, the dipoles in the emitter section are inverted such that negative poles thereof are directed toward the upper electrode (i.e., positive-oriented polarization inversion is occurred). This causes the electrons accumulated at an upper portion of the emitter section to be subjected to Coulomb repulsion. As a result, the electrons are emitted through the fine through holes of the upper electrode (refer to, for example, Japanese Patent Application Laid-Open (kokai) No. 2005-142134).

In this electron-emitting device, pressure in a space where the upper surface of the emitter section and the upper electrode are present is reduced to substantial vacuum. However, a relatively large number of gas molecules remain in the eaves structure portion (i.e., a space between the lower surface of the upper electrode and the upper surface of the emitter section). The gas molecules are ionized during emission of electrodes and attracted to the emitter section by Coulomb attraction generated by the dipoles in the emitter section. As a result, oxygen atoms present in an upper portion of the emitter section leave the emitter section, and the upper surface of the emitter section is metalized (or the crystallographic structure of the emitter section is decomposed); thus, the polarization inversions (the positive-oriented and the negative-oriented polarization inversions) mentioned above in an upper portion of the emitter section becomes to be hard. That is, the upper portion of the emitter section ceases to serve as dielectric. Additionally, if the upper surface of the emitter section is metalized, surface resistance of the upper surface of the emitter section lowers. Accordingly, when electrons accumulated on the upper surface of the emitter section are to be emitted through the fine through holes of the upper electrode, the amount of electrons which flow on the upper surface of the emitter section to the upper electrode and are absorbed therein increases. As a result, the amount of emitted electrons decreases (electron-emitting capability is deteriorated) as the number of the electron-emitting operations of the electron-emitting device increases.

### SUMMARY OF THE INVENTION

In view of the foregoing, one of objects of the present invention is to provide an electron-emitting device in which the amount of emitted electrons is unlikely to drop with the number of electron-emitting operations.

To achieve the above object, an electron-emitting device of the present invention comprises an emitter section formed from a dielectric material, a lower electrode formed on a lower portion of the emitter section, and an upper electrode formed on an upper portion of the emitter section opposed to (or in opposition to) the lower electrode to sandwich the emitter section between the same and the lower electrode, and having a plurality of fine through holes formed therein, lower surfaces of portions surrounding the fine through holes thereof being separated from and facing the emitter section. The electron-emitting device emits electrons from the emitter section through the fine through holes of the upper electrode through application of a drive voltage between the lower electrode and the upper electrode. A protective film of oxide is formed on portions of an upper surface of the emitter section separated from the lower surface of the upper electrode and/or on portions of the upper surface of the emitter section exposed to the exterior of the upper electrode through the fine through holes of the upper electrode.

Portions of the upper surface of the emitter section separated from the lower surface of the upper electrode and portions of the upper surface of the emitter section exposed to the exterior of the upper electrode through the fine through holes of the upper electrode are important for an electrode-emitting operations (accumulation and emission of electrons) caused by polarization inversions operation of the emitter section. The above-mentioned provision of the protective film of oxide on those portions of the upper surface of the emitter section protects these portions from attack of ionized gas molecules. As a result, the upper surface of the emitter section becomes unlikely to be metalized. Therefore, there can be provided an electron-emitting device which shows a character that the amount of emitted electrons is unlikely to drop as the number of electron-emitting operations increases.

Preferably, the protective film is formed in contact with both of the upper surface of the emitter section and the lower surface of the upper electrode at those portions of the upper surface of the emitter section where the upper surface of the emitter section starts to separate from the lower surface of the upper electrode, and is formed in contact with only the upper surface of the emitter section at those portions of the upper surface of the emitter section which are separated from the lower surface of the upper electrode.

Those portions of the upper surface of the emitter section where the upper surface of the emitter section starts to separate from the lower surface of the upper electrode are triple junctions where the emitter section, the upper electrode, and a surrounding substance (including vacuum) are in contact with one another. Since an electric field is concentrated on these portions, these portions are important for an operation of supplying electrons from the upper electrode to the emitter section. Accordingly, through protection of these portions of the upper surface of the emitter section by providing the protective film thereon as mentioned above, there can be provided an electron-emitting device having a character that the amount of emitted electrons is unlikely to drop with the number of electron-emitting operations.

Preferably, the protective film is formed on the entire upper surface of the emitter section.

The upper electrode and/or the emitter section thermally contracts and expands. In the case where the emitter section is formed from a piezoelectric/electrostrictive/antiferroelectric material, application of a drive voltage causes deformation of the emitter section. Additionally, Coulomb force associated with an electron-emitting operation is exerted between the upper electrode and the emitter section. Accordingly, in microscopic view, the positions of the above-mentioned triple junctions also vary. Therefore, by forming the protective film on the entire upper surface of the emitter section as mentioned above, even when the positions of the triple junctions vary, the upper surface of the emitter section at the triple junctions can be protected at all times by the protective film. As a result, there can be provided an electron-emitting device having a character that the amount of emitted electrons is more unlikely to drop with the number of electron-emitting operations.

Preferably, the emitter section is formed from ceramic, and the protective film is of an oxide which contains atoms that are not replaced with atoms forming a crystallographic structure of the emitter section.

In the case where the emitter section, which is formed from a dielectric material, is formed from ceramic, the emitter section is generally formed by firing. In the course of firing, if a material (substance) used to form the emitter section contains an oxide which contains atoms (nonreplacement atoms) that are not replaced with atoms forming the crystallographic structure of the emitter section, the oxide precipitates in grain boundaries of the emitter section. Since the grain boundaries are also present at the surface (upper surface) of the emitter section, utilization of such nonreplacement atoms facilitates formation of an oxide containing the nonreplacement atoms on the upper surface of the emitter section. In other words, if the protective film is of an oxide which contains atoms that are not replaced with atoms forming the crystallographic structure of the emitter section, there can be provided an electron-emitting device having a character that the protective film can be readily formed.

Preferably, the atoms that are not replaced with the atoms forming the crystallographic structure of the emitter section are of silicon (Si).

In the course of forming the emitter section by firing, an oxide which contains silicon (Si) precipitates in grain boundaries of the emitter section in the form of silica (SiO₂) and the like. Since these oxides melt at a temperature lower than a firing temperature for the emitter section, and the crystallographic structure of the emitter section is irregular, subjecting the emitter section formed by firing to another heat treatment causes the oxides to readily diffuse at the upper surface of the emitter section (particularly in the grain boundaries of the emitter section). Accordingly, utilization of this diffusion enables easy formation of a protective film containing silicon on the upper surface of the emitter section. That is, if the protective film is of an oxide containing silicon, which is not replaced with atoms forming the crystallographic structure of the emitter section, there can be provided an electron-emitting device having a character that the protective film can be readily formed.

Preferably, the emitter section is formed from a compound including lead (Pb).

In the case where the emitter section contains lead, an oxide which contains silicon is present in the form of lead silicate glass (xSiO₂-yPbO) in grain boundaries of the surface of the emitter section. Since the melting point of lead silicate glass is low, and the crystallographic structure of grain boundaries of the emitter section is irregular, subjecting the emitter section formed by firing to another heat treatment causes lead silicate glass to melt and readily diffuse along the upper surface of the emitter section (particularly in the grain boundaries of the emitter section). Accordingly, through utilization of this diffusion, there can be provided an electron-emitting device having a character that the protective film can be readily formed on the emitter section.

The present invention further provides a method of manufacturing the above-mentioned electron-emitting device in which the protective film is formed on the upper surface of the emitter section. The method comprises a step of adding silicon or a compound containing silicon to a material used to form the emitter section, and firing the material for forming the emitter section and a step of forming a protective film of silicon oxide on the upper surface of the emitter section through application of heat to the emitter section in a reducing atmosphere.

In the case where, as mentioned above, a material used to form the emitter section contains silicon, heating (firing) for forming the emitter section causes silicon to precipitate in the form of oxide, such as silica (SiO₂) and/or lead silicate glass (xSiO₂-yPbO), in grain boundaries of the upper surface of the emitter section, since atoms of silicon are not replaced with atoms forming the crystallographic structure of the emitter section which is formed from a dielectric material.

Subjecting the emitter section formed by firing to another heating operation (another heat treatment) in a reducing atmosphere causes the molten silicon-containing oxide present in the grain boundaries to be preferentially reduced and volatilize as SiO. Subsequently, when the reducing atmosphere is lost, SiO is oxidized, and resultant silica (SiO₂) deposits on the upper surface of the emitter section, thereby forming a protective film. As a result, the method readily manufactures an electron-emitting device in which a protective film of oxide is formed on the upper surface of the emitter section.

Preferably, the step of forming the protective film is practiced by applying heat to the emitter section while a pasty, organometallic compound for forming the upper electrode is spread on the upper surface of the emitter section.

When firing heat is applied to the pasty and organometallic compound, an organic moiety of the organometallic compound decomposes while taking away oxygen. As a result, a reducing atmosphere is established in the vicinity of the surface of the emitter section. Accordingly, this method can readily form the protective film of oxide on the upper surface of the emitter section simultaneously with formation of the upper electrode by means of firing.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a fragmentary, sectional view of an electron-emitting device according to a first embodiment of the present invention;

FIG. 2 is a fragmentary, sectional view of the electron-emitting device of FIG. 1;

FIG. 3 is a fragmentary plan view of the electron-emitting device of FIG. 1;

FIG. 4 is an enlarged fragmentary, sectional view of the electron-emitting device of FIG. 1;

FIG. 5 is an enlarged fragmentary, sectional view of the electron-emitting device of FIG. 1;

FIG. 6 is an enlarged fragmentary plan view of an upper electrode shown in FIG. 1;

FIG. 7 is a view showing another example of through holes of the upper electrode shown in FIG. 1;

FIG. 8 is a view showing a further example of through holes of the upper electrode shown in FIG. 1;

FIG. 9 is a view showing a still further example of through holes of the upper electrode shown in FIG. 1;

FIG. 10 is a view showing yet another example of through holes of the upper electrode shown in FIG. 1;

FIG. 11 is an enlarged fragmentary, sectional view of the upper electrodes and the emitter section shown in FIG. 1;

FIG. 12 is a view showing a state of the electron-emitting device shown in FIG. 1;

FIG. 13 is a graph of a voltage-polarization characteristic of the emitter section shown in FIG. 1;

FIG. 14 is a view showing another state of the electron-emitting device shown in FIG. 1;

FIG. 15 is a view showing a further state of the electron-emitting device shown in FIG. 1;

FIG. 16 is a view showing a still further state of the electron-emitting device shown in FIG. 1;

FIG. 17 is a view showing yet another state of the electron-emitting device shown in FIG. 1;

FIG. 18 is a view showing another state of the electron-emitting device shown in FIG. 1;

FIG. 19 is a view showing a state of emitted electrons in an electron-emitting device which does not have focusing electrodes;

FIG. 20 is a view showing a state of emitted electrons in the electron-emitting device shown in FIG. 1;

FIG. 21 is an enlarged fragmentary, sectional view of the upper electrodes and the emitter section of an electron-emitting device manufactured by an example manufacturing method of the present invention;

FIG. 22 is a view showing the process of formation of a protective film in the example manufacturing method of the present invention;

FIG. 23 is a view showing the process of formation of the protective film in the example manufacturing method of the present invention;

FIG. 24 is a graph showing the number of pulses vs. the amount of emitted electrons represented by relative value as tested on the electron-emitting device shown in FIG. 1 (an electron-emitting device which has the protective film) and on an electron-emitting device which does not have the protective film;

FIG. 25 is an electron micrograph of the surface (upper surface) of the emitter section of the electron-emitting device shown in FIG. 1;

FIG. 26 is a photograph showing detection of silicon (Si), by Auger electron spectroscopy, on the surface (upper surface) of the emitter section of the electron-emitting device shown in FIG. 25;

FIG. 27 is a photograph showing detection of lead (Pb), by Auger electron spectroscopy, on the surface (upper surface) of the emitter section of the electron-emitting device shown in FIG. 25;

FIG. 28 is a photograph showing detection of carbon (C), by Auger electron spectroscopy, on the surface (upper surface) of the emitter section of the electron-emitting device shown in FIG. 25;

FIG. 29 is an electron micrograph of the surface (upper surface) of the emitter section of an electron-emitting device whose durability is poor;

FIG. 30 is a photograph showing detection of silicon (Si), by Auger electron spectroscopy, on the surface (upper surface) of the emitter section of the electron-emitting device shown in FIG. 29;

FIG. 31 is a photograph showing detection of lead (Pb), by Auger electron spectroscopy, on the surface (upper surface) of the emitter section of the electron-emitting device shown in FIG. 29;

FIG. 32 is a photograph showing detection of carbon (C), by Auger electron spectroscopy, on the surface (upper surface) of the emitter section of the electron-emitting device shown in FIG. 29;

FIG. 33 is an enlarged fragmentary, sectional view of an electron-emitting device according to a second embodiment of the present invention; and

FIG. 34 is a fragmentary, sectional view of an electron-emitting device according to a modified embodiment of the present invention.

### DESCRIPTION OF THE PREFERRED EMBODIMENTS

Embodiments of an electron-emitting device and a method of manufacturing the same according to the present invention will next be described with reference to the drawings. This electron-emitting device can be applied to various kinds of apparatus, such as electron irradiation apparatus, light sources, and electronic-component-manufacturing apparatus. The following description assumes application to a display. Structure:

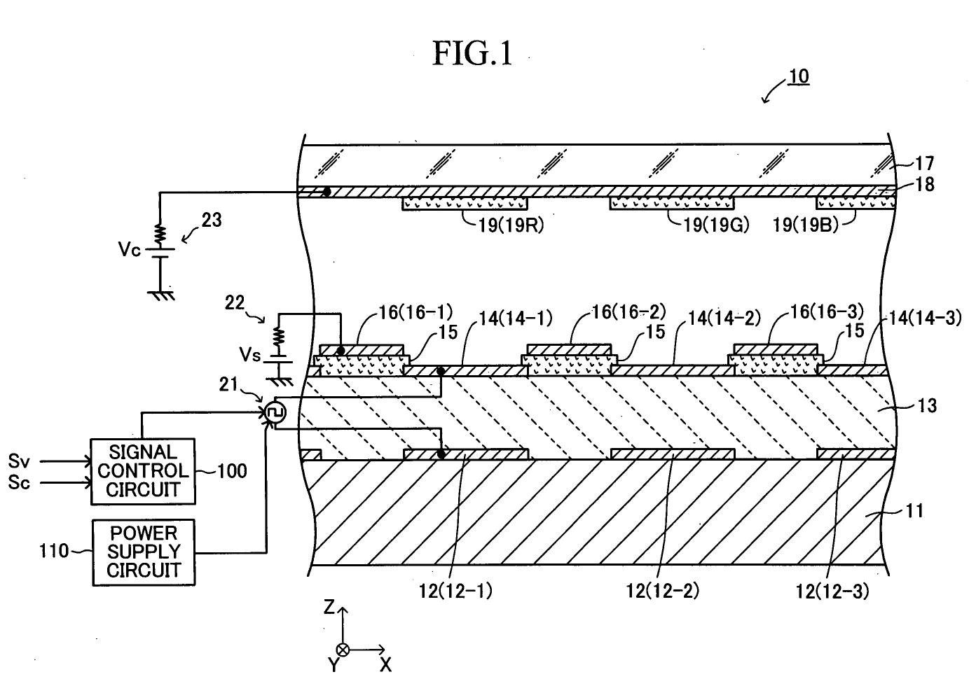

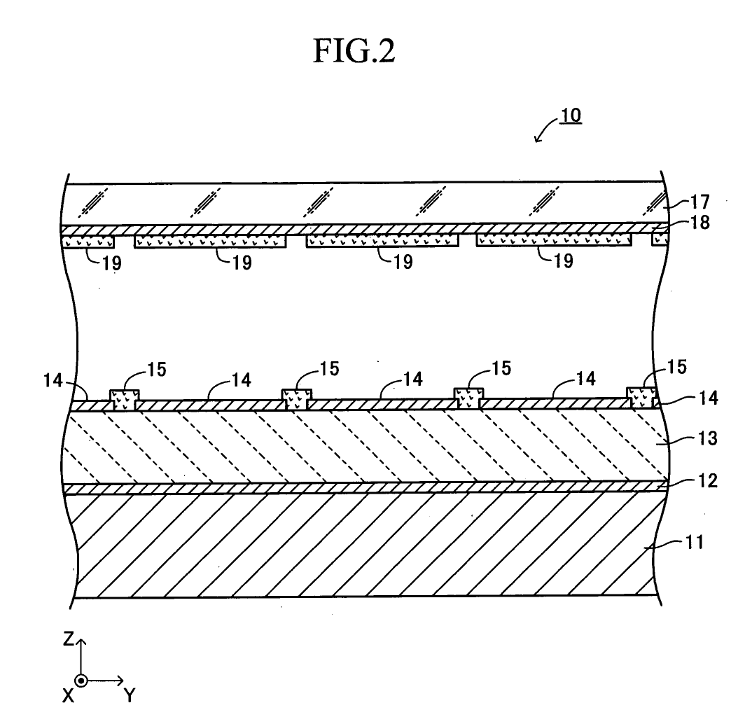

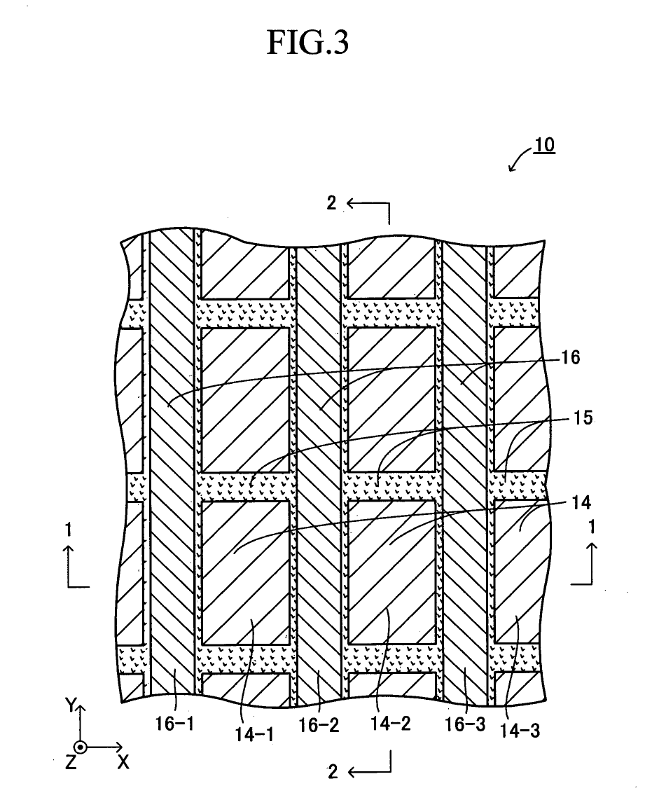

As shown in FIGS. 1 to 3, an electron-emitting device 10 according to an embodiment of the present invention includes a substrate 11, a plurality of lower electrodes (lower electrode layers) 12, an emitter section 13, a plurality of upper electrodes (upper electrode layers) 14, an insulating layer 15, and a plurality of focusing electrodes (focusing electrode layers) 16. FIG. 1 is a sectional view of the electron-emitting device 10 taken along line 1-1 of FIG. 3, which is a fragmentary plan view of the electron-emitting device 10. FIG.2is a sectional view of the electron-emitting device 10 taken along line 2-2 of FIG. 3.

The substrate 11 has an upper surface and a lower surface in parallel with a plane defined by the mutually perpendicular X-axis and Y-axis (X-Y plane) and has a thickness direction along the Z-axis perpendicular to the X-axis and the Y-axis. The substrate 11 is formed from glass or a ceramic material. Examples of this ceramic material include a material which contains zirconium oxide as a main component, a material which contains aluminum oxide as a main component, and a material which contains a mixture of aluminum oxide and zirconium oxide as a main component.

The lower electrodes 12 are formed from an electrically conductive substance, which will be described later, and are each formed on the upper surface of the substrate 11 in the form of a layer. As viewed in plane, the lower electrodes 12 each assume the form of a strip having a longitudinal direction along the Y-axis. As shown in FIG. 1, two adjacent lower electrodes 12 are separated from each other in the X-axis direction by a predetermined distance. In FIG. 1, for convenience of description, the lower electrodes 12 denoted by reference numerals 12-1, 12-2, and 12-3 are called a first lower electrode, a second lower electrode, and a third lower electrode, respectively.

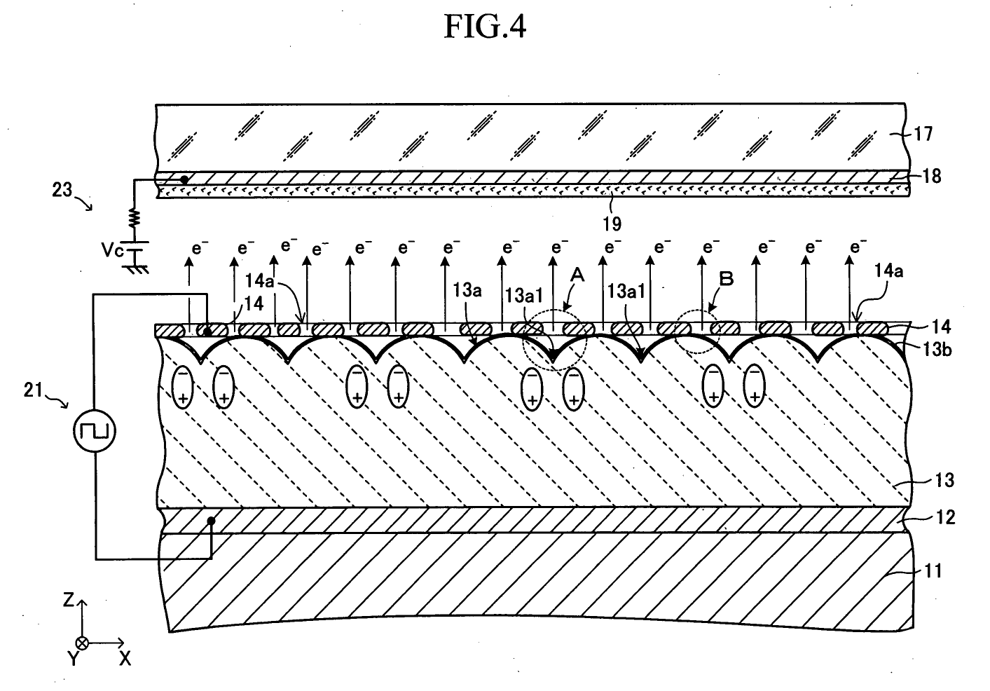

The emitter section 13 is formed from a material whose specific dielectric constant is high and which contains lead (Pb) as a main component (for example, a 3-component material PMN-PT-PZ of magnesium lead niobate (PMN), lead titanate (PT), and lead zirconate (PZ); the material will be described later), and is formed on the upper surface of the substrate 11 and on the upper surfaces of the lower electrodes 12. The emitter section 13 is a thin plate which has upper and lower surfaces parallel to the X-Y plane, and has a thickness direction along the Z-axis. As shown on an enlarged scale in FIG. 4, concavities and convexities 13a associated with grain boundaries 13a1 of the dielectric material are formed at the upper surface of the emitter section 13.

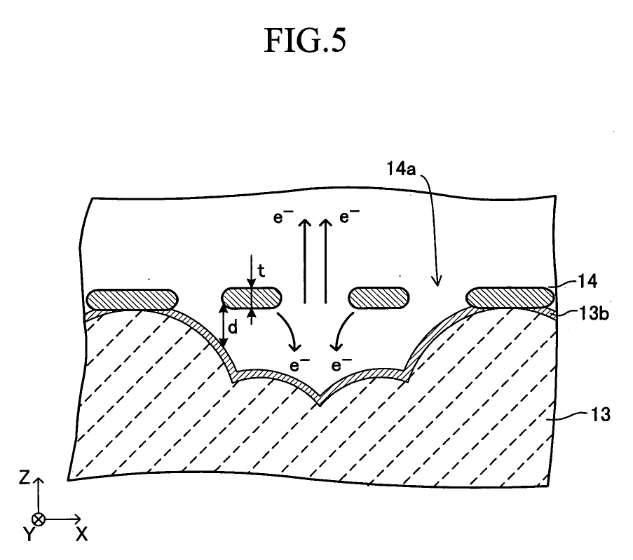

As shown in FIG. 4 and FIG. 5, which is an enlarged fragmentary, sectional view of an upper-surface portion of the emitter section 13, a very thin protective film 13b is formed on the upper surface of the emitter section 13. In the present embodiment, the protective film 13b is of silica (SiO₂, a silicon-containing oxide). The protective film 13b has a thickness of 1 nm to 100 nm, preferably 1 nm to 20 nm, more preferably 1 nm to 5 nm.

The upper electrodes 14 are formed from an electrically conductive substance, which will be described later, and are each formed on the upper surface of the emitter section 13 in the form of a layer. As shown in FIG. 3, as viewed in plane, the upper electrodes 14 each assume a rectangular shape having short sides and long sides which extend along the X-axis and the Y-axis, respectively. A plurality of the upper electrodes 14 are arranged in matrix array while being spaced apart from one another.

The upper electrodes 14 are disposed in opposition to (or opposed to) the corresponding lower electrodes 12 in such a manner as to overlie the respective lower electrodes 12 as viewed in plane. In FIGS. 1 and 3, for convenience of description, the upper electrodes 14 denoted by reference numerals 14-1, 14-2, and 14-3 are called a first upper electrode, a second upper electrode, and a third upper electrode, respectively. A plurality of the upper electrodes 14 arranged in the X-axis direction are connected together by means of an unillustrated connection conductor to thereby be maintained at the same electric potential. Notably, in order to stabilize emission of electrons and to protect the electrodes and the emitter section, resistors may be formed adjacent to the respective upper electrodes, and the upper electrodes may be connected to the connection conductor via the respective resistors.

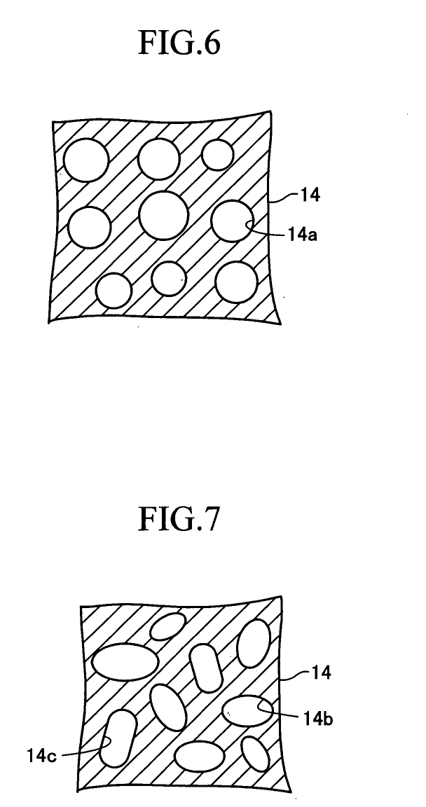

As shown in FIGS. 4 and 5 and FIG. 6, which is an enlarged fragmentary plan view of the upper electrode 14, the upper electrodes 14 have a plurality of fine through holes 14a formed therein. The through holes 14a have a generally circular shape as viewed in plane. The through holes 14a have a mean diameter of preferably 10 nm to 10 μm, more preferably 10 nm to less than 100 nm. The through holes 14a of the upper electrodes 14 according to the present embodiment have a mean diameter of 10 nm to less than 100 nm.

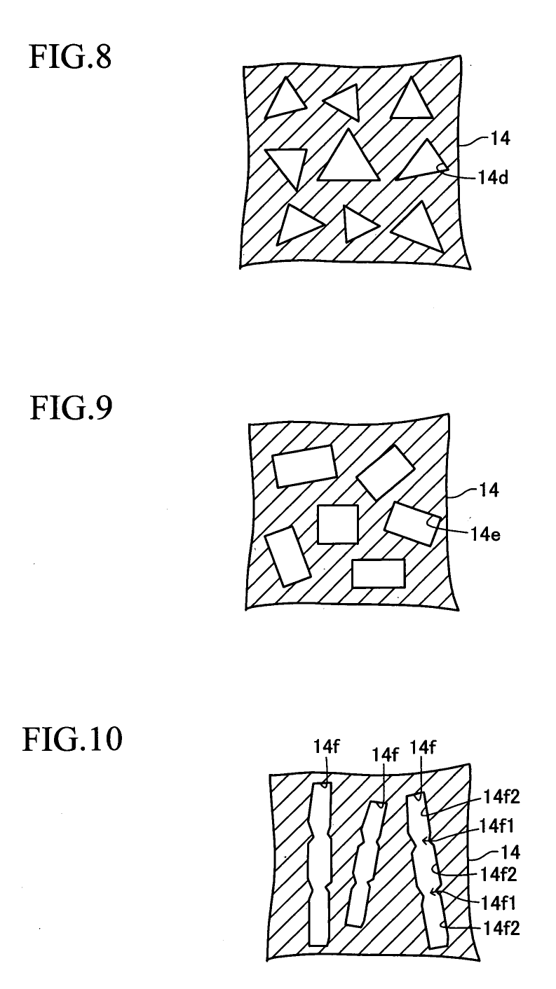

Note that, if the shape of a through hole is circular, the mean diameter of the through hole is equal to the diameter of the circle. If the shape of a through hole is other than circular, the mean diameter of the through hole is defined as the average of lengths of a plurality of different line segments passing through the center of the through hole. The shape of a through hole is not limited to a generally circular shape as in the case of the above-mentioned through hole 14a. As shown in FIGS. 7 to 10, each through hole may assume a shape composed mainly of curved lines, such as a generally elliptic shape 14b or a generally elongated circular shape (track shape) 14c, a shape composed mainly of straight lines, such as a generally triangular shape 14d or a generally rectangular shape 14e, or a slit shape 14f. Also, each through hole may assume a sickle shape, a boomerang shape, or the like.

The slit-like through hole 14f shown in FIG. 10 has narrow portions 14f1. Accordingly, the through hole 14f can be considered to be a continuation of a plurality of through holes 14f2 having a generally rectangular shape. Thus, the mean diameter of the through hole 14f is defined as the mean diameter of the individual rectangular through holes 14f2. If a slit-like through hole does not have such narrow portions, the width of the through hole (the width of slit) is considered its mean diameter. That is, in the case of a through hole having a slit-like shape, if the through hole has a substantially independent through-hole portion, the mean diameter of the independent through-hole portion may be handled as the mean diameter of the slit-like through hole; and if the slit-like through hole has a generally constant width, the width may be handled as the mean diameter thereof. This definition of a mean diameter for a slit-like through hole is also applied to a through hole having the shape of a curved slit, such as a sickle shape or a boomerang shape.

The mean diameter of such through holes (through hole 14a, etc.) is desirably smaller than the grain diameter of a dielectric material used to form the emitter section 13. A greater amount of electrons can be emitted through a through hole immediately under which the grain boundary 13a1 of the emitter section is absent (see the region in a circle B represented by the broken line of FIG. 4) than through a through hole immediately under which the grain boundary 13a1 of the emitter section is present (see the region in a circle A represented by the broken line of FIG. 4). Accordingly, forming the through holes 14a of the upper electrodes 14 such that the mean diameter thereof is smaller than the grain diameter of a dielectric material used to form the emitter section 13 results in an increase in the number of the through holes 14a immediately under which a grain boundary of the emitter section 13 is absent. As a result, electrons can be emitted in a greater amount. In order to increase the number of through holes immediately under which a grain boundary of a dielectric material used to form the emitter section 13 is absent, the diameter of the through holes 14a is preferably ⅕ or less (more preferably 1/10 or less, most preferably 1/20 or less) of the grain diameter of the dielectric material.

Preferably, the through holes 14a are pores formed by crystal grains of metal (spaces surrounded by crystal grains of metal which are joined together in the course of formation of crystal grains of metal).

Formation of pores (through holes 14a) by crystal grains of metal is practiced, for example, as follows. As will be described later, an organometallic compound is applied to and spread on the upper surface of a substance used to form the emitter section, by a thick-film deposition process, such as screen printing, spraying, or dipping, followed by firing at a predetermined temperature. The surface of the thus-formed upper electrode (surfaces of crystal grains of metal) exhibits higher crystallinity (the surface of metal exhibits higher crystallinity) as compared with the surface of a through hole formed in a later step by laser machining or the like. Accordingly, it is presumed that emission of electrons is facilitated. Through holes having surfaces of crystal grains of metal can be yielded by sintering the metal. Therefore, an electron-emitting device in which through holes have surfaces of crystal grains of metal is free from damage to the emitter surface, which could otherwise result from formation of through holes by laser machining or the like. Additionally, forming pores (through holes) in the upper electrode by means of crystal grains of metal has an advantage of being free from generation of fine cutting dust, which could otherwise result from formation of through holes by machining.

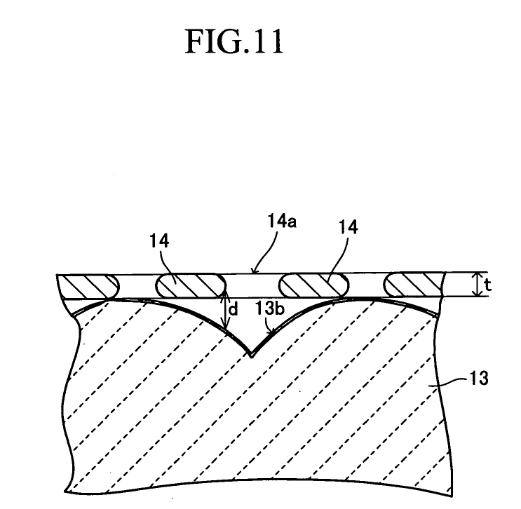

The thickness t of the upper electrodes 14 (see FIG. 5 or 11) is 0.01 μm to 10 μm, preferably 0.05 μm to 1 μm. The maximum distance d between the emitter section 13 (upper surface of the emitter section 13) and the surface of a portion of the upper electrode 14 around (peripheral to) the through hole 14a (14b to 14f) which faces the emitter section 13 is from greater than 0 μm to 10 μm, preferably 0.01 μm to 1 μm.

A region where the upper electrode 14 and the lower electrode 12 overlap as viewed in plane forms a single element for emitting electrons. For example, in the electron-emitting device shown in FIG. 1, the first lower electrode 12-1, the first upper electrode 14-1, and a portion of the emitter section 13 sandwiched between the first lower electrode 12-1 and the first upper electrode 14-1 constitute a first element. Also, the second lower electrode 12-2, the second upper electrode 14-2, and a portion of the emitter section 13 sandwiched between the second lower electrode 12-2 and the second upper electrode 14-2 constitute a second element. Furthermore, the third lower electrode 12-3, the third upper electrode 14-3, and a portion of the emitter section 13 sandwiched between the third lower electrode 12-3 and the third upper electrode 14-3 constitute a third element. In this manner, the electron-emitting device 10 includes a plurality of independent electron emitters. In other words, an electron-emitting device can be called an electron emitter (element).

Referring again to FIGS. 1 to 3, the insulating layer 15 is formed on the upper surface of the emitter section 13 in such a manner as to fill spaces among the plurality of upper electrodes 14. The insulating layer 15 is greater in thickness (length along the Z-axis) than the upper electrodes 14. As shown in FIGS. 1 and 2, the insulating layer 15 overlies end portions along the X- and Y-axes of the upper electrodes 14.

The focusing electrodes 16 are formed from an electrically conductive substance (herein, silver) and are each formed on the insulating layer 15 in the form of a layer. As shown in FIG. 3, as viewed in plane, the focusing electrodes 16 each assume the form of a strip having a longitudinal direction along the Y-axis. As viewed in plane, the focusing electrodes 16 are each formed between the upper electrodes 14 adjacent to each other along the X-axis (a focusing electrode is formed between and located obliquely upward of the upper electrodes of the elements adjacent to each other along the X-axis (the term “upward” means the positive direction of the Z-axis, and hereinafter, the same is applied); i.e., a focusing electrode is located slightly away from the upper electrodes in the respective electron-emitting directions). All of the focusing electrodes 16 are connected together by means of an unillustrated electrically conductive layer to thereby be maintained at the same electric potential.

In FIGS. 1 and 3, for convenience of description, the focusing electrodes 16 denoted by reference numerals 16-1, 16-2, and 16-3 are called a first focusing electrode, a second focusing electrode, and a third focusing electrode, respectively. By use of this denomination, the second focusing electrode 16-2 can be said to be formed between and located obliquely upward of the first upper electrode 14-1 of the first element and the second upper electrode 14-2 of the second element. Similarly, the third focusing electrode 16-3 can be said to be formed between and located obliquely upward of the second upper electrode 14-2 of the second element and the third upper electrode 14-3 of the third element.

This electron-emitting device 10 further includes a transparent plate 17, a collector electrode (collector electrode layer) 18, and phosphors 19.

The transparent plate 17 is formed from a transparent material (herein, glass or acrylic) and is disposed a predetermined distance above (in the positive direction of the Z-axis) the upper electrodes 14. The transparent plate 17 is disposed in opposition to the substrate 11 and such that its upper and lower surfaces are in parallel with the upper surface of the emitter section 13 and the upper surfaces of the upper electrodes 14 (in the X-Y plane).

The collector electrode 18 is formed from an electrically conductive substance (herein, a transparent, electrically conductive film of ITO) and is formed on the entire lower surface of the transparent plate 17 in the form of a layer. That is, the collector electrode 18 is disposed above and in opposition to the upper electrodes 14.

The phosphors 19 are excited through irradiation with electrons and emit light in red, green, or blue. As viewed in plane, the phosphors 19 have substantially the same shape as that of the upper electrodes 14 and are disposed in such a manner as to overlie the respective upper electrodes 14. In FIG. 1, the phosphors 19 denoted by reference numerals 19R, 19G, and 19B emit light in red, green, and blue, respectively. Accordingly, in the present embodiment, the red phosphor 19R is located immediately above (in the positive direction of the Z-axis) the first upper electrode 14-1; the green phosphor 19G is located immediately above the second upper electrode 14-2; and the blue phosphor 19B is located immediately above the third upper electrode 14-3. Notably, a space surrounded by the emitter section 13, the upper electrodes 14, the insulating layer 15, the focusing electrodes 16, and the transparent plate 17 (collector electrode 18) is maintained at substantial vacuum (preferably 10² Pa to 10⁻⁶ Pa, more preferably 10⁻³ Pa to 10⁻⁵ Pa).

In other words, the transparent plate 17 and the collector electrode 18 are space formation members which, together with unillustrated side wall portions of the electron-emitting device 10, define a closed space. This closed space is maintained at substantial vacuum. Accordingly, the elements (at least upper portions of the emitter section 13 and the upper electrodes 14 of the elements) of the electron-emitting device 10 are disposed within the closed space, which is maintained at substantial vacuum by the space formation members.

Additionally, as shown in FIG. 1, the electron-emitting device 10 includes a drive voltage application circuit (drive voltage application means) 21, a focusing-electrode electric-potential application circuit (focusing-electrode electric-potential-difference application means) 22, and a collector voltage application circuit (collector voltage application means) 23.

The drive voltage application circuit 21 is connected to a signal control circuit 100 and a power supply circuit 110 and applies a drive voltage Vin between the upper electrodes 14 and the lower electrodes 12 opposed to each other (i.e., to elements) on the basis of a signal from the signal control circuit 100.

The focusing-electrode electric-potential application circuit 22 is connected to the focusing electrodes 16 and applies a predetermined negative electric-potential (voltage) Vs to the focusing electrodes 16. The collector voltage application circuit 23 applies a predetermined positive voltage (collector voltage) Vc to the collector electrode 18.

### Principle and Operation of Electron Emission:

Next, the principle of operation of the electron-emitting device 10 configured as described above will be described with respect to a single element.

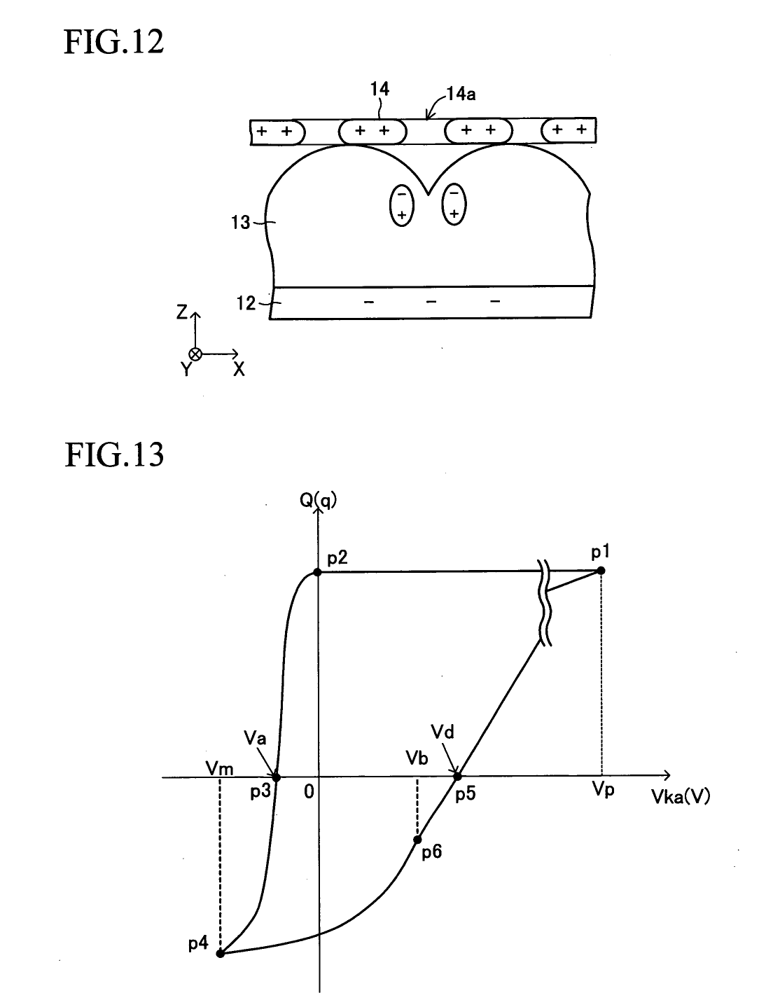

First, description starts with a state shown in FIG. 12. In this state, an actual electric-potential difference Vka (i.e., element voltage Vka) between the lower electrode 12, whose electric potential serves as a reference potential, and the upper electrode 14 is held at a positive predetermined voltage Vp. This state arises immediately after electrons accumulated at an upper portion of the emitter section 13 are all emitted; i.e., in this state, no electrons are accumulated at the upper portion of the emitter section 13. In this state, the negative poles of dipoles in the emitter section 13 face toward the upper surface of the emitter section 13 (in the positive direction of the Z-axis; i.e., toward the upper electrode 14). This state is at a point p1 on the graph shown in FIG. 13. The graph of FIG. 13 shows a voltage-polarization characteristic of the emitter section 13. In the graph of FIG. 13, the element voltage Vka is plotted along the horizontal axis, and the charge Q accumulated in the element is plotted along the vertical axis.

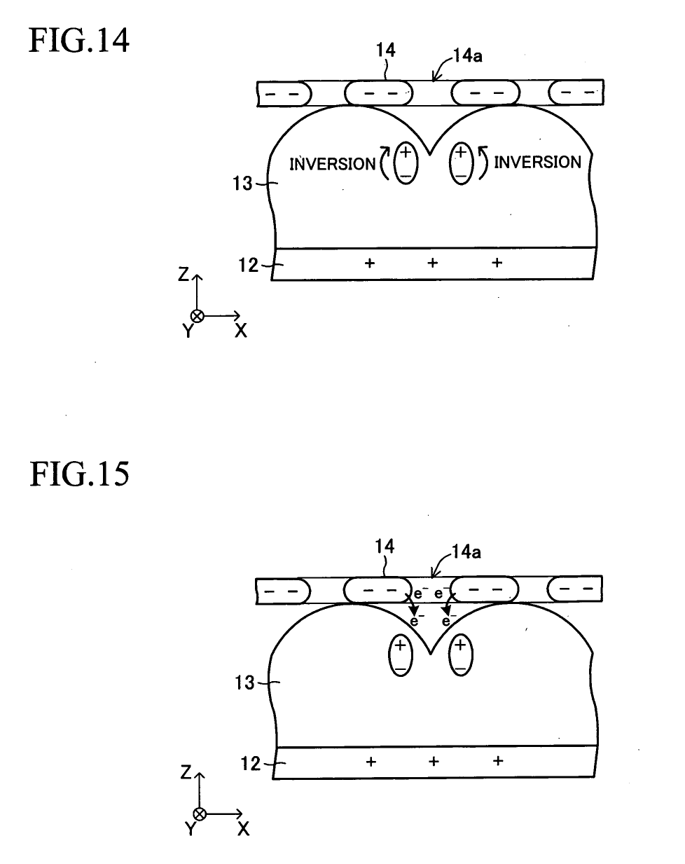

In this state, the drive voltage application circuit 21 decreases the drive voltage Vin toward a first voltage Vm, which is a negative predetermined voltage. This causes the element voltage Vka to decrease toward a point p3 via a point p2 in FIG. 13. When the element voltage Vka decreases to a voltage near a negative coercive electric-field voltage Va shown in FIG. 13, the direction of dipoles in the emitter section 13 begins to be inverted. Specifically, as shown in FIG. 14, polarization inversion (negative-oriented polarization inversion) begins.

This negative-oriented polarization inversion increases the intensity of electric field (concentration of electric field occurs) at a periphery (tip end portion) of the upper electrode 14 which defines the through hole 14a and in a contact region (triple junction) among the upper electrode 14, the upper surface of the emitter section 13, and their ambient medium (in this case, vacuum). As a result, as shown in FIG. 15, the upper electrode 14 begins to supply electrons toward the emitter section 13.

The thus-supplied electrons are accumulated mainly at an upper portion of the emitter section 13 in the vicinity of a region located immediately under a portion of the upper electrode 14 around the through hole 14a (hereinafter, may be referred to merely as “vicinity of a region immediately under the through hole 14a”). Subsequently, when negative-oriented polarization inversion is completed after elapse of a predetermined time, the element voltage Vka sharply changes toward the negative predetermined voltage Vm. This state is at a point p4 in FIG. 13.

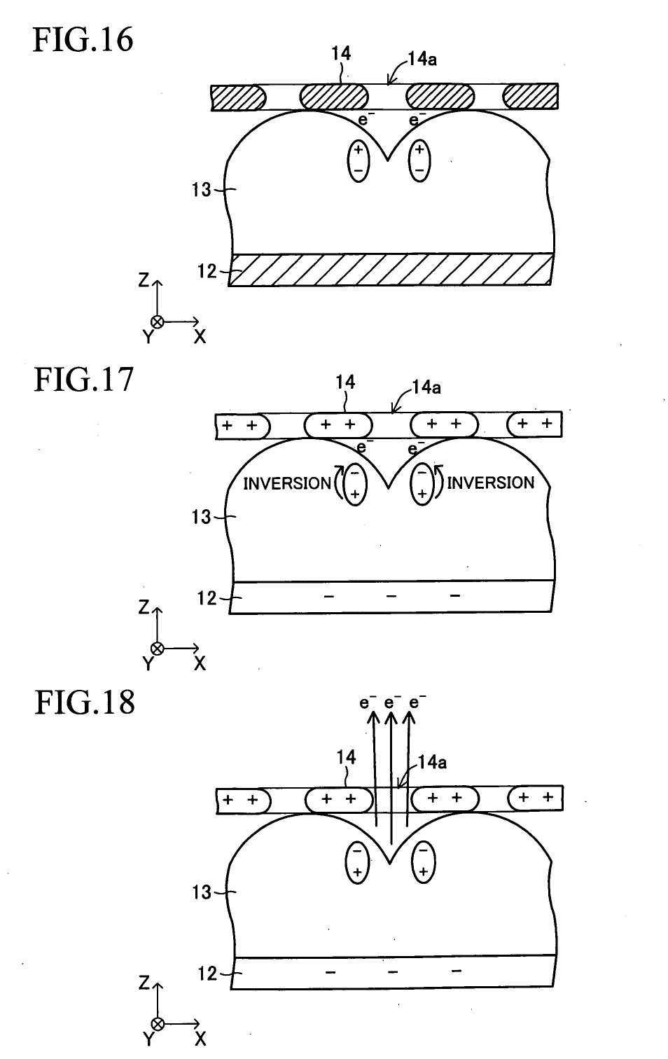

Next, the drive voltage application circuit 21 changes the drive voltage Vin to the second voltage Vp, which is a positive predetermined voltage. This initiates an increase in the element voltage Vka. The emitter section 13 maintains its charged state as shown in FIG. 16 until the element voltage Vka reaches a voltage Vb (point p6), which is lower than a positive coercive electric-field voltage Vd corresponding to a point p5 in FIG. 13. Subsequently, the element voltage Vka reaches a voltage near the positive coercive electric-field voltage Vd. As a result, electrons accumulated in the vicinity of a region immediately under the through hole 14a are attracted toward the upper electrode 14 by an electric potential applied to the upper electrode 14. About that time, dipoles begin to turn around such that their negative poles face toward the upper surface of the emitter section 13. In other words, as shown in FIG. 17, dipoles are inverted again (positive-oriented polarization inversion begins). This state is near a point p5 in FIG. 13.

In this state, electrons accumulated in the vicinity of a region immediately under the through hole 14a are attracted toward the upper electrode 14, because they are subjected to Coulomb repulsion induced by dipoles which have been inverted such that their negative poles face toward the upper surface of the emitter section 13, and because of an electric potential applied to the upper electrode 14. As a result, as shown in FIG. 18, electrons which have been accumulated in the vicinity of a region immediately under the through hole 14a are emitted upward (in the positive direction of the Z-axis) through the through hole 14a.

Upon completion of positive-oriented polarization inversion, the element voltage Vka begins to sharply increase, and electrons are actively emitted. Subsequently, emission of electrons is completed, and the element voltage Vka reaches the second voltage Vp. As a result, the emitter section 13 returns to its initial state (state at the point p1 in FIG. 13) shown in FIG. 12. Thus is completed description of the principle of a series of operations concerning accumulation of electrons (turning off of light) and emission of electrons (turning on of light or emission of light).

In the case where a plurality of elements are present, the drive voltage application circuit 21 decreases the drive voltage Vin to the first voltage Vm for accumulation of electrons only for the upper electrodes 14 of those elements from which electrons are to be emitted, while maintaining the drive voltage Vin at “0” for the upper electrodes 14 of those elements which do not need to emit electrons, and thereafter, the drive voltage application circuit 21 changes the drive voltage Vin to the second voltage Vp for all of the upper electrodes 14 all at once (simultaneously). This causes emission of electrons only from the upper electrodes 14 (through holes 14a) of those elements which have accumulated electrons at upper portions of the emitter section 13. Accordingly, polarization inversion does not occur in portions of the emitter section 13 in the vicinity of those upper electrodes 14 which do not need to carry out emission of electrons.

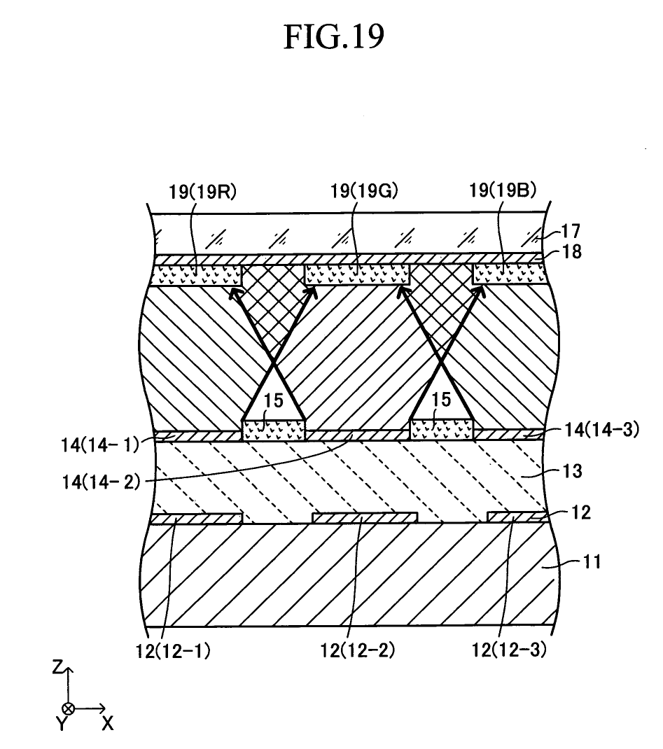

Meanwhile, as shown in FIG. 19, when electrons are emitted through the through holes 14a of the upper electrode 14, electrons advance in the positive direction of the Z-axis while gradually spreading (like a cone). As a result, electrons emitted from a single upper electrode 14 (e.g., second upper electrode 14-2) may reach not only a phosphor (e.g., green phosphor 19G) located immediately above the same upper electrode 14 but also neighboring phosphors (red phosphor 19R and blue phosphor 19B). This causes a drop in color purity, resulting in a drop in sharpness of image.

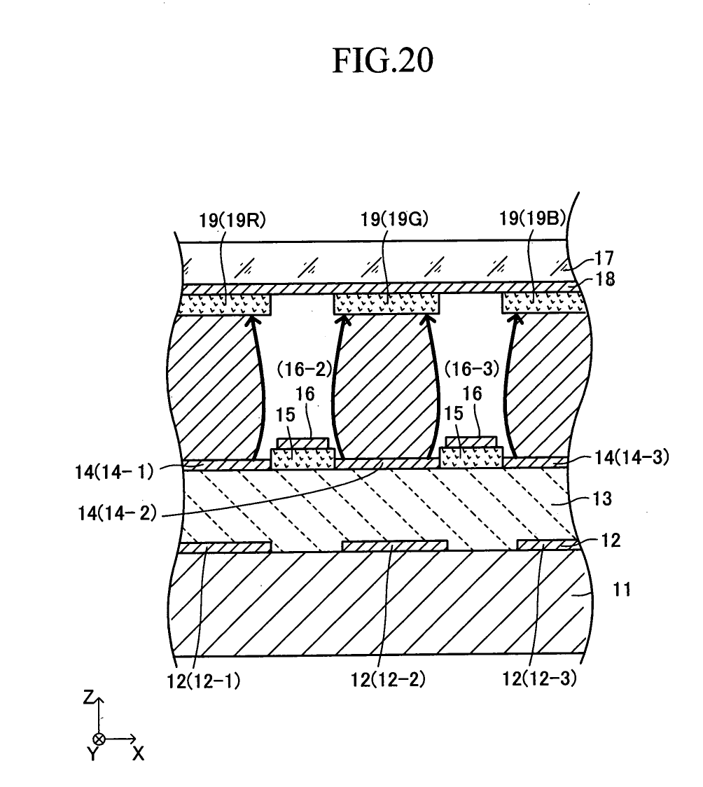

By contrast, the electron-emitting device 10 according to the present embodiment has the focusing electrodes 16, to which a negative electric-potential is applied. The focusing electrodes 16 are each disposed between the adjacent upper electrodes 14 (between the upper electrodes of adjacent elements) and slightly above (in the positive direction of the Z-axis) the upper electrodes 14. Accordingly, as shown in FIG. 20, electrons emitted through the through holes 14a of the upper electrode 14 advance substantially straight upward without spreading by virtue of electric fields induced by the focusing electrodes 16. Furthermore, in the electron-emitting device 10, the upper electrodes 14 have the through holes 14a each having a mean diameter of 10 nm to less than 100 nm, so that electrons can be emitted at high efficiency. Also, in the electron-emitting device 10, since the through holes 14a are very small, emitted electrons do not spread. That is, the electron-emitting device 10 can emit electrons in a direction perpendicular to the plane of the emitter section 13 and to the plane of the upper electrodes 14 with good accuracy.

As a result, electrons emitted from the first upper electrode 14-1 reach only the red phosphor 19R; electrons emitted from the second upper electrode 14-2 reach only the green phosphor 19G; and electrons emitted from the third upper electrode 14-3 reach only the blue phosphor 19B. Accordingly, a display is free from a drop in color purity and thus can exhibit a sharp image.

The collector voltage application circuit 23 applies a predetermined positive voltage Vc to the collector electrode 18. This causes the collector electrode 18 to generate an electric field. While being accelerated (enhanced in energy) by this electric field, electrons emitted from the emitter section 13 advance upward of the upper electrodes 14. Thus, the phosphors 19 are irradiated with electrons having high energy, thereby exhibiting high brightness.

### Example Materials and Example Manufacturing Methods for Component Members:

Next, materials and manufacturing methods for component members of the above-described electron-emitting device will be described.

### Lower Electrode 12:

An electrically conductive substance (material) is used to form the lower electrode 12. The lower electrode 12 can be formed by an appropriate film forming process. Examples of such a thick-film forming process include screen printing, spraying, and dipping. Examples of such a thin-film forming process include an ion beam process, sputtering, vacuum vapor deposition, ion plating, CVD, and plating. Substances preferably used to form the lower electrode 12 are listed below.
(1) Conductors (e.g., simple metals or alloys) resistant to high-temperature oxidizing atmosphere:

Example: metals having high melting point, such as platinum, iridium, palladium, rhodium, and molybdenum.

Example: metals whose main component is silver-palladium, silver-platinum, platinum-palladium, or a like alloy.
(2) Mixtures of an insulating ceramic material and a simple metal, resistant to high-temperature oxidizing atmosphere:

Example: cermet material of platinum and a ceramic material.
(3) Mixtures of an insulating ceramic material and an alloy, resistant to high-temperature oxidizing atmosphere.
(4) Carbon or graphite materials.
(5) Conductor films of gold, silver, copper, aluminum, chromium, molybdenum, tungsten, nickel, and the like formed by thin-film deposition processes such as sputtering.
(6) Gold resinate printed films, silver resinate printed films, and platinum resinate printed films.

In the case where a ceramic material is added to an electrode material, the ceramic material is added in an amount of preferably 5 vol. % to 30 vol. %. Also, a material similar to that for the upper electrode 14, which will be described later, may be used. The thickness of the lower electrode is preferably 20 μm or less, more preferably 5 μm or less.

### Emitter Section 13:

A dielectric material having a relatively high specific dielectric constant (e.g., a specific dielectric constant of 1,000 or higher) can be employed to form the emitter section 13. Substances preferably used to form the emitter section 13 are listed below. In the present embodiment, any of the following substances is fired for forming the emitter section 13 having a crystallographic structure. Before firing, atoms (e.g., atoms of silicon (Si)) that are not (or can not be) replaced with atoms forming this crystallographic structure are mixed into the substances listed below. In the case of silicon, an oxide which contains silicon can be mixed into the substances listed below. Examples of the silicon-containing oxide include silicon dioxide (SiO₂), soda glass, and borosilicate glass.
(1) Barium titanate, lead zirconate, magnesium lead niobate, nickel lead niobate, zinc lead niobate, manganese lead niobate, magnesium lead tantalate, nickel lead tantalate, antimony lead stannate, lead titanate, magnesium lead tungstate, cobalt lead niobate, and the like.
(2) Ceramic materials which contain in combination the substances mentioned above in (1).
(3) Ceramic materials mentioned above in (2) which further contain singly oxides of lanthanum, calcium, strontium, molybdenum, tungsten, barium, niobium, zinc, nickel, manganese, cerium, and the like. Ceramic materials mentioned above in (2) which further contain in combination the oxides. Ceramic materials mentioned above in (2) which further contain singly or in combination the oxides, as well as other compound(s), as appropriate. (4) Substances whose main components contain singly or in combination the substances mentioned above in (1) in an amount of 50% or more.

Notably, for example, in a 2-component material of magnesium lead niobate (PMN) and lead titanate (PT) “nPMN-mPT” (n, m: mole ratio), increase of the mole ratio of PMN lowers the Curie point and can increase specific dielectric constant at room temperature. Particularly, an nPMN-mPT in which n=0.85 to 1.0 and m=1.0−n is very preferred as a material for the emitter section, since a specific dielectric constant of 3,000 or more is obtained. For example, an nPMN-mPT in which n=0.91 and m=0.09 has a specific dielectric constant of 15,000 at room temperature. An nPMN-mPT in which n=0.95 and m=0.05 has a specific dielectric constant of 20,000 at room temperature.

Also, for example, in a 3-component material of magnesium lead niobate (PMN), lead titanate (PT), and lead zirconate (PZ) “PMN-PT-PZ,” increase of the mole ratio of PMN can increase specific dielectric constant. Further, in the 3-component material, the employment of a composition near the morphotropic phase boundary (MPB) between the tetragonal system and the pseudo-cubic system or between the tetragonal system and the rhombohedral system can increase specific dielectric constant.

For example, with PMN:PT:PZ=0.375:0.375:0.25, a specific dielectric constant of 5,500 is obtained, and with PMN:PT:PZ=0.5:0.375:0.125, a specific dielectric constant of 4,500 is obtained. Thus, a PMN-PT-PZ having such a composition is particularly preferred as a material for the emitter section.

Further preferably, dielectric constant is enhanced by means of adding platinum or a like metal to these dielectric materials within such a range of amount as not to impair the insulating property. In this case, for example, platinum may be added to the dielectric material in an amount of 20% by weight.

A piezoelectric/electrostrictive material, an antiferroelectric material, or the like can be used to form the emitter section. A piezoelectric/electrostrictive material used to form the emitter section can be a ceramic material which contains singly or in combination lead zirconate, magnesium lead niobate, nickel lead niobate, zinc lead niobate, manganese lead niobate, magnesium lead tantalate, nickel lead tantalate, antimony lead stannate, lead titanate, barium titanate, magnesium lead tungstate, cobalt lead niobate, and the like.

Needless to say, ceramic materials whose main components contain the above compounds singly or in combination in an amount of 50% by weight or more can be used to form the emitter section. Among the above-mentioned ceramic materials, a ceramic material which contains lead zirconate is most frequently used as a piezoelectric/electrostrictive material for the emitter section.

In the case where a ceramic material is used as a piezoelectric/electrostrictive material, the ceramic material may be any of the above ceramic materials which further contains singly or in combination oxides of lanthanum, calcium, strontium, molybdenum, tungsten, barium, niobium, zinc, nickel, manganese, cerium, and the like, as well as other compound(s), as appropriate. The ceramic material may be any of the above ceramic materials which further contains singly or in combination SiO₂, CeO₂, and Pb₅Ge₃O₁₁. Specifically, the ceramic material is preferably a PT-PZ-PMN piezoelectric material to which 0.2 wt % SiO₂, 0.1 wt % CeO₂, or 1 wt % to 2 wt % Pb₅Ge₃O₁₁ is added.

More specifically, preferably, for example, the ceramic material contains a main component composed of magnesium lead niobate, lead zirconate, and lead titanate and further contains lanthanum and strontium.

The piezoelectric/electrostrictive material may be dense or porous. When a porous piezoelectric/electrostrictive material is used, its porosity is preferably 40% or less.

When an antiferroelectric material is used to form the emitter section 13, desirably, the antiferroelectric material contains lead zirconate as a main component, contains a main component composed of lead zirconate and lead stannate, is a lead zirconate material to which lanthanum oxide is added, or is a lead-zirconate-lead-stannate material to which lead niobate is added.

The antiferroelectric material may be porous. When a porous antiferroelectric material is used, its porosity is preferably 30% or less.

Use of strontium tantalate bismuthate (SrBi₂Ta₂O₉) to form the emitter section is preferred, since polarization inversion fatigue is low. Such materials having low polarization inversion fatigue are layered ferroelectric compounds and represented by the general formula (BiO₂)²⁺(Aₘ₋₁BₘO₃ₘ₊₁)²⁻, wherein ions of metal A are, for example, Ca²⁺, Sr²⁺, Ba²⁺, Pb²⁺, Bi³⁺, La³⁺, and ions of metal B are, for example, Ti⁴⁺, Ta⁵⁺, and Nb⁵⁺. Further, barium titanate piezoelectric ceramic materials, lead zirconate piezoelectric ceramic materials, and PZT piezoelectric ceramic materials can be rendered semiconductor by adding additives. This enables electric field concentration in the vicinity of the interface between the emitter section 13 and the upper electrode, which contributes to emission of electrons, through uneven electric field distribution within the emitter section 13.

By means of mixing a glass component, such as lead borosilicate glass, or other low-melting-point compound (e.g., bismuth oxide), into piezoelectric/electrostrictive/antiferroelectric ceramic materials, firing temperature for the emitter section 13 can be lowered.

When a piezoelectric/electrostrictive/antiferroelectric ceramic material is used to form the emitter section, the emitter section may assume the form of a molded sheet, a laminated sheet, or a laminate composed of a substrate and the sheet laminated thereon or bonded thereto.

In formation of the emitter section 13, the above-mentioned material mixed with a silicon-containing oxide is subjected to heating to a predetermined firing temperature (e.g., 1,000° C. to 1,300° C.) and firing at the temperature by use of an electric furnace. A more specific method of forming the emitter section 13 will be described in the following description of methods for forming the upper electrode 14 and the protective film 13b.

In the above-mentioned example, before firing is performed for forming the emitter section 13, an oxide which contains silicon is mixed into a material used to form the emitter section 13. In this connection, since “substances which act as sintering aids for sintering of the emitter section,” such as Pb₅Ge₃O₁₁, a low-melting-point compound (e.g., bismuth oxide), and B₂O₃—ZnO glass, also precipitate in grain boundaries of the emitter section 13 in the course of firing for formation of the emitter section 13, these substances can be considered effective components for formation of the protective film 13b. Accordingly, before firing is performed for forming the emitter section 13, these substances may be mixed into a material used to form the emitter section 13.

### Upper Electrode 14:

The upper electrode 14 can be formed into a desired shape by any of the following methods:
(1) A method of patterning by a screen printing process, a light lithography process, or a like process.
(2) A method of patterning through elimination of unnecessary portions by a laser machining process using excimer laser, YAG laser, or like laser or by a machining process such as slicing or ultrasonic machining.

In order to form the aforementioned fine through holes in the upper electrode 14, the upper electrode 14 is formed by applying and spreading an organometallic compound onto the upper surface of a substance which is to become the emitter section 13, by a thick-film deposition process, such as screen printing, spraying, or dipping, followed by quick heating to a predetermined temperature and firing at the temperature by use of an infrared heating furnace or a like furnace. As will be described later, this firing step is accompanied by a mechanism of forming the protective film 13b of a silicon-containing oxide at an upper portion of the emitter section 13. In contrast to other methods for forming fine through holes (e.g., a light lithography process, an electron beam or X-ray lithography process, and a machining process using excimer laser, YAG laser, or focused ion beam (FIB)), firing does not require expensive equipment and can form the upper electrode 14 in the atmosphere. Therefore, firing is advantageous for forming the upper electrode 14 having fine through holes therein.

The above-mentioned heating-firing method for forming the upper electrode 14 will next be described specifically.

As mentioned above, the upper electrode 14 can be formed by firing only an organometallic compound which contains only a single metal of, for example, silver (Ag), gold (Au), iridium (Ir), rhodium (Rh), ruthenium (Ru), platinum (Pt), palladium (Pd), aluminum (Al), copper (Cu), nickel (Ni), chromium (Cr), molybdenum (Mo), tungsten (W), and titanium (Ti). An organometallic compound which contains a metal other than noble metals is desirably reduced and fired.

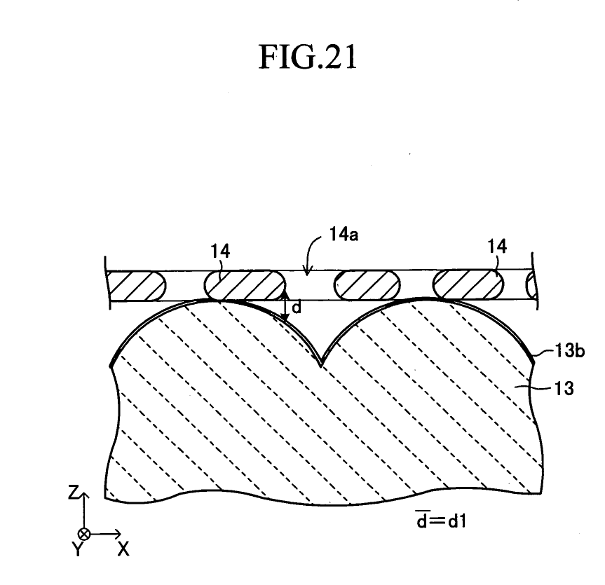

By use of an infrared heating furnace (infrared quick-heating furnace), the present embodiment performs heating at a very high temperature-raising rate and subsequent firing. As shown in FIG. 21, this method can readily form the upper electrodes 14 having good flatness and having a large number of fine through holes 14a each having a very small mean diameter of 10 nm to less than 100 nm. Specific example manufacturing methods for the emitter section 13 (including the protective film 13b) and the upper electrodes 14 will be described below.

### Example Manufacturing Methods:

### A: Manufacture of Emitter Section

Step 1: There is prepared a material having a composition, in terms of mole ratios, of PMN:PT:PZ=0.375:0.375:0.25, in which 0.7 mol % lead (Pb) is replaced with lanthanum (La), and 6 mol % lead (Pb) is replaced with strontium (Sr). Specifically, this material is prepared by the steps of mixing material powders of lead oxide, titanium oxide, zirconium oxide, magnesium carbonate, niobium pentoxide, lanthanum oxide, and strontium carbonate so as to obtain the above composition, and heat-treating the resultant mixture at 1,110° C. for 2 hours.

Step 2: The material obtained in Step 1 is powdered in a pot mill.

Step 3: A powder of SiO₂ is mixedly added in an amount of 0.01 wt % to the synthetic powder obtained in Step 2, followed by addition of solvent (terpineol) and resin (polyvinyl butyral). The resultant mixture is kneaded into a paste-like material. Notably, SiO₂ is added in an amount of preferably 0.001 wt % to 0.1 wt %, more preferably 0.001 wt % to 0.005 wt %.

Step 4: A film is formed from the paste-like material obtained in Step 3 by screen printing. The film is dried at 150° C., thereby yielding a film having a thickness of 40 μm. The resultant film is held in an atmosphere of 1,270° C. for 3 hours; i.e., subjected to firing at a firing temperature of 1,270° C.

### B: Manufacture of Upper Electrode

Step 5: A paste-like organometallic compound which contains a single predetermined metal (herein, Pt) is spread in the form of a film on the upper surface of the fired emitter section 13 by screen printing, followed by drying at 100° C. The thickness of the thus-dried film is set to 10 μm.

Step 6: The temperature of the infrared heating furnace accommodating the above-mentioned organometallic compound is raised to 600° C. (firing temperature) at a rate of 20° C./sec (20° C. per second; i.e., 1,200° C./min). The infrared heating furnace is held at the temperature for 30 minutes for firing (heat-treating) the above-mentioned organometallic compound. As a result, the emitter section 13 is heated again.

Step 5 and Step 6 constitute a process which includes a temperature-raising step for raising the temperature of a film of an organometallic compound containing a single metal and spread on the emitter section, at a predetermined temperature-raising rate (herein, 20° C./sec) and which is for forming the upper electrode through firing of the organometallic compound film.

This firing process including the rapid temperature-raising step heats the fired emitter section 13 as well and causes formation of the protective film 13b on the upper surface of the emitter section 13. A process of forming the protective film 13b will be described below.

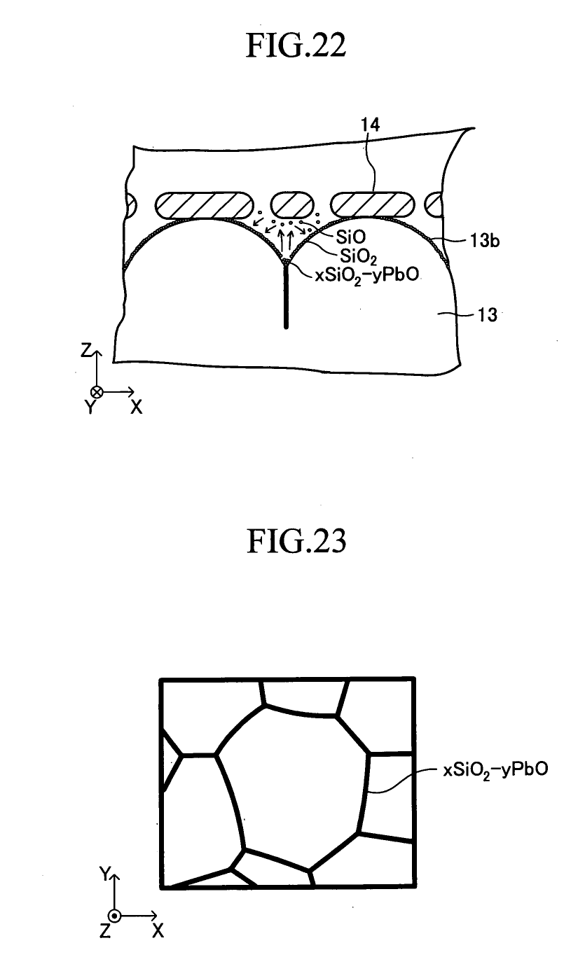

Silicon is an atom (element) that is not replaced with atoms forming the crystallographic structure of the emitter section 13 (when the emitter section 13 is formed from the material mentioned in Step 1, atoms forming the crystallographic structure of the emitter section 13 are of lead, titanium, zirconium, magnesium, niobium, lanthanum, strontium, and oxygen). Accordingly, when the emitter section 13 is formed through firing in Step 4, silicon contained in SiO₂ precipitates in grain boundaries of the emitter section 13 in the form of silicon oxides such as SiO₂. Precipitated silicon oxides react with a portion of atoms of lead, which is a constituent atom of the emitter section 13, to form lead borosilicate glass (xSiO₂-yPbO). Thus-formed lead borosilicate glass is present in grain boundaries of the emitter section 13 (see FIGS. 22 and 23).

Next, while the paste-like organometallic compound which has been spread in the form of a film in Step 5 is subjected to firing in Step 6, the organic moiety (organic component) of the organometallic compound decomposes while taking away oxygen. Accordingly, a reducing atmosphere is established in the vicinity of the upper surface of the emitter section 13. At the same time, silicon contained in lead borosilicate glass and present in grain boundaries of the emitter section 13 is reduced in the reducing atmosphere, thereby volatilizing as SiO gas.

Subsequently, when substances which form the above-mentioned reducing atmosphere (substances resulting from decomposition of the organic moiety) vanish, the SiO gas is oxidized again. The resultant oxide deposits on the upper surface of the emitter section 13, thereby forming the protective film 13b (see FIG. 22). The volatilized SiO gas stays in the vicinity of the emitter section 13 conceivably because the upper electrodes 14 which are concurrently formed in the course of firing prevent scattering of the SiO gas. In the reducing atmosphere, lead (Pb) and lead oxide (PbO), which are components of the emitter section 13, also volatilize. However, conceivably, SiO contained in lead borosilicate glass having low melting point volatilizes predominantly (i.e., in a larger amount).

Thus are formed the upper electrodes 14, the emitter section 13, and the protective film 13b. Note that, as the amount of organic matter contained in an organometallic compound used to form the upper electrodes 14 is greater, and as the temperature-raising rate in heating of the organometallic compound is higher, the reducing capability of the above-mentioned reducing atmosphere becomes higher. Experiments have revealed that the amount of organic matter contained in the paste-like organometallic compound used to form the upper electrodes 14 is desirably 60% or more by volume as measured after the paste is dried and that the temperature-raising rate (heating rate) for firing of the upper electrodes 14 is desirably 5° C./sec or higher. It has also been revealed that the firing temperature for the upper electrodes 14 is desirably 500° C. to 650° C.

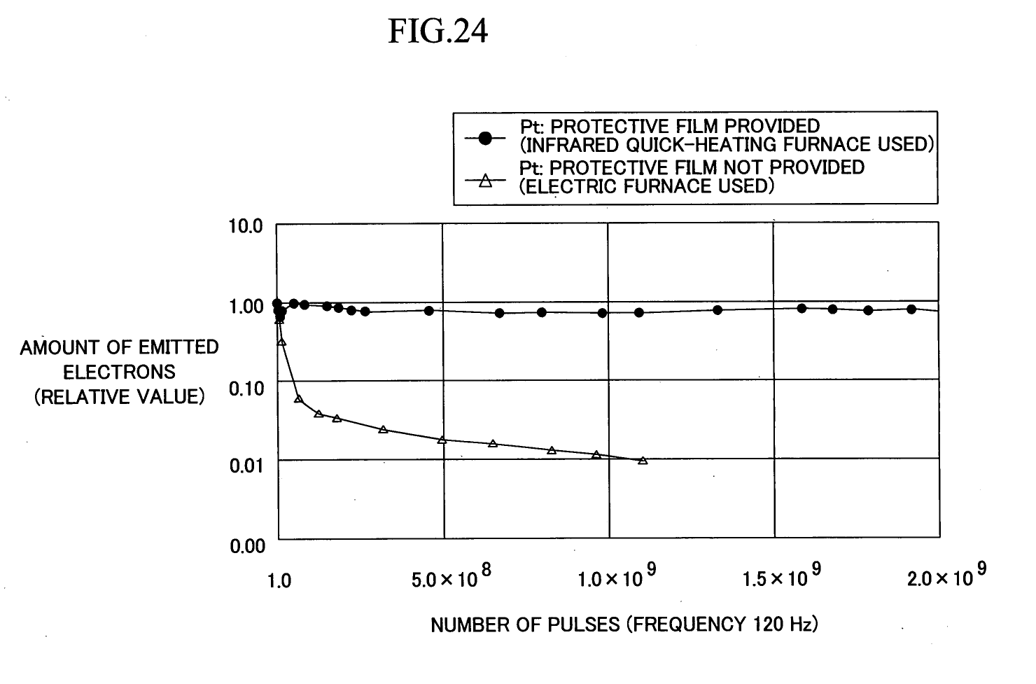

FIG. 24 is a graph showing the results of experiment for comparing durability between an electron-emitting device which is manufactured by the above-described manufacturing method and has the protective film 13b, and an electron-emitting device which does not have the protective film 13b. The horizontal axis of FIG. 24 represents the number of pulses each effecting a single accumulation and emission of electrons (the number of electron-emitting operations), and the vertical axis of FIG. 24 represents the amount of emitted electrons which is obtained from emission of light from the phosphors 19 caused to emit light by the emitted electrons and which is represented by relative value (the amount of emitted electrons as represented in relation to that measured at the beginning of the durability test which is represented by “1”). Notably, the working frequency was 120 Hz. In FIG. 24, plotting in solid circles represents a relative value indicative of the amount of emitted electrons of the electron-emitting device which is manufactured by the above-described manufacturing method and has the protective film 13b, and plotting in triangles represents a relative value indicative of the amount of emitted electrons of the electron-emitting device which does not have the protective film 13b.

This electron-emitting device which does not have the protective film 13b is manufactured by employment of the following Step 6′ instead of Step 6 of the above-described example manufacturing method for the upper electrodes.

Step 6′: The temperature of an electric furnace is raised to 700° C. (firing temperature) at a rate of 47° C./min. The electric furnace is held at the temperature for 30 minutes for firing (heat-treating) the above-mentioned organometallic compound.

As is apparent from FIG. 24, in the electron-emitting device which does not have the protective film 13b, as the number of pulses increases, the amount of emitted electrons decreases. By contrast, in the electron-emitting device 10 which has the protective film 13b, the amount of emitted electrons remains almost unchanged with the number of pulses. This indicates that the electron-emitting device 10 having the protective film 13b exhibits excellent durability.

Conceivably, the presence of the protective film 13b enhances durability for the following reason. Portions of the upper surface of the emitter section 13 separated from the lower surfaces of the upper electrodes 14 and portions of the upper surface of the emitter section 13 exposed to the exterior of the upper electrodes 14 through the fine through holes 14a of the upper electrodes 14 are important for an electrode-emitting operation effected by a polarization inversion operation of the emitter section 13. Accordingly, as in the case of the electron-emitting device 10, the provision of a protective film of oxide (in this case, a silicon oxide film) on those portions of the upper surface of the emitter section 13 protects the upper surface of the emitter section 13 from attack of ionized gas molecules. As a result, the upper surface of the emitter section 13 becomes unlikely to be metalized. Therefore, even when the number of electron-emitting operations increases, polarization inversion occurs in the vicinity of the upper surface of the emitter section 13. Thus, the amount of emitted electrons is unlikely to drop.

The inventors of the present invention analyzed the upper surface of the emitter section 13 of the electron-emitting device 10 which exhibits excellent durability as represented by plotting in solid circles in FIG. 24, and the upper surface of the emitter section of the electron-emitting device which exhibits poor durability as represented by plotting in triangles, by a scanning electron microscope (SEM) and Auger electron spectroscopy. This analysis was conducted on these electron-emitting devices which had undergone a durability test.

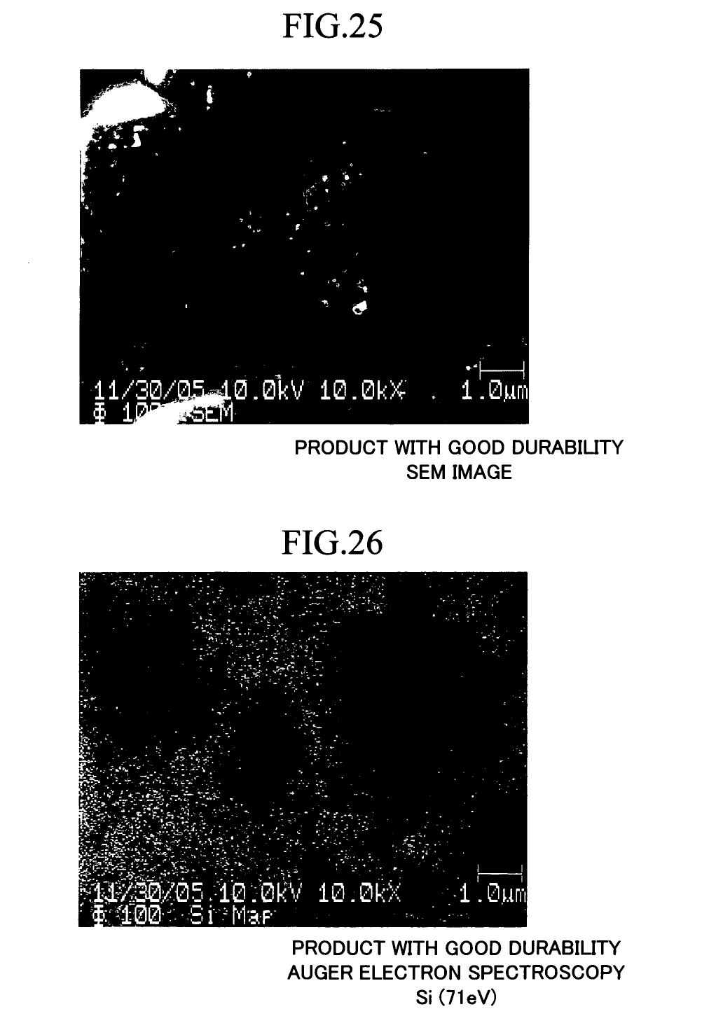

FIG. 25 is a photograph (SEM image) of the surface (upper surface) of the emitter section 13 of the electron-emitting device 10 taken by the scanning electron microscope. FIGS. 26, 27, and 28 are photographs showing detection of silicon (Si), lead (Pb), and carbon (C), respectively, on the surface (upper surface) of the emitter section 13 of the electron-emitting device 10 by Auger electron spectroscopy. In FIGS. 26 to 28, bright regions (white regions) are where object atoms of detection are present.

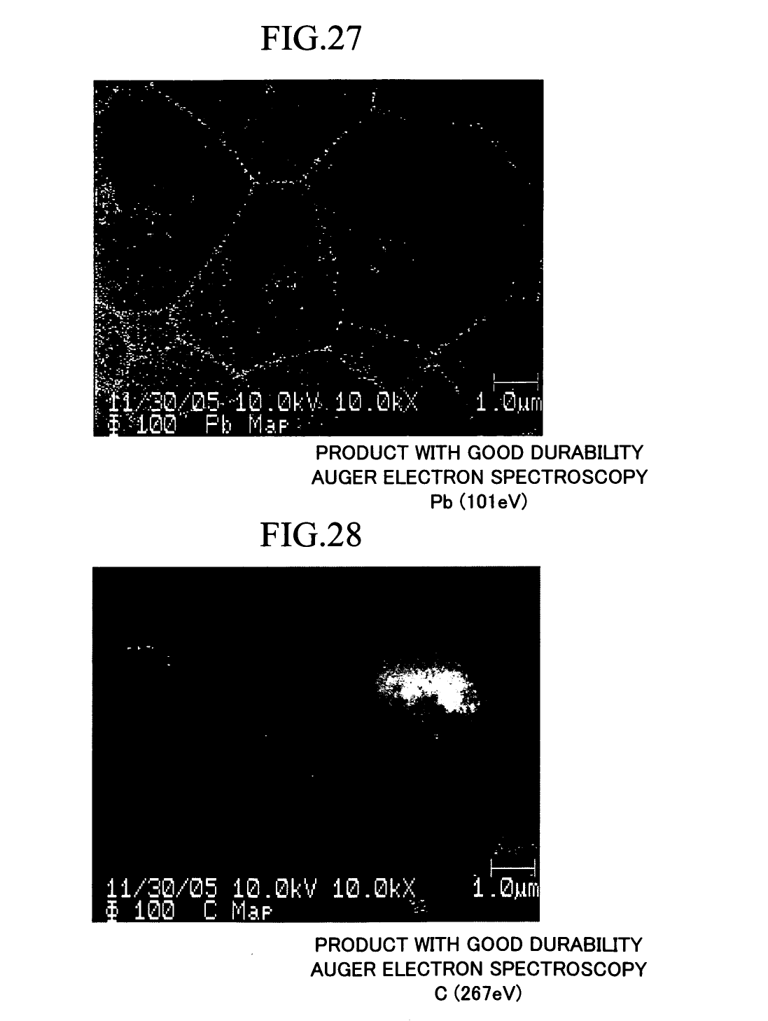

FIG. 26 shows presence of silicon on the surface of the emitter section 13 of the electron-emitting device 10. Analysis of the surface of the emitter section 13 by a photoelectron spectroscope (XPS, ESCA) has confirmed that the detected silicon is contained in silicon oxide. Comparison between FIG. 26 and FIG. 27 indicates that lead is absent on crystal grain surfaces of the emitter section 13. This means that the surface of the emitter section 13 of the electron-emitting device 10 of excellent durability is covered with the protective film 13b of silicon oxide. This also means that SiO volatilizes from the surface of the emitter section 13 predominantly (i.e., in a larger amount) over lead (Pb) and lead oxide (PbO) in a reducing atmosphere. Furthermore, it is understood from FIGS. 25, 26, and 28 that carbon is present in a large amount at top portions (convex portions) of crystal grains of the surface of the emitter section 13. Conceivably, through electron-emitting operations, this carbon has deposited on the silicon oxide SiO₂ which covers the emitter section 13. In other words, this carbon appears as dark regions (where silicon is unlikely to be detected) in FIG. 26.

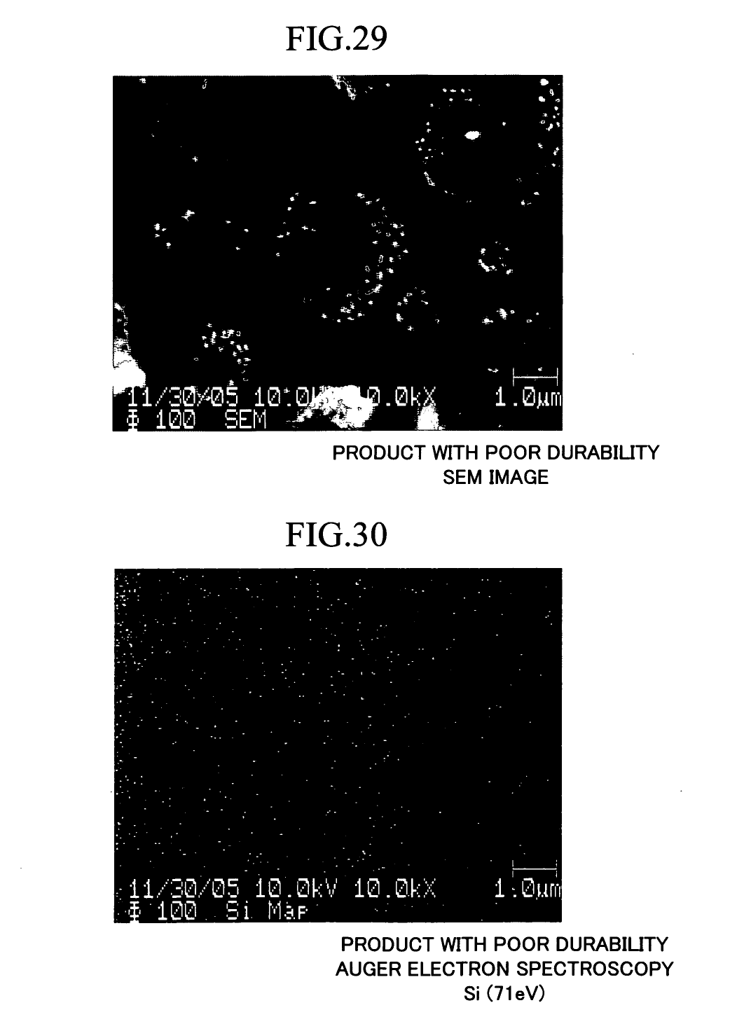

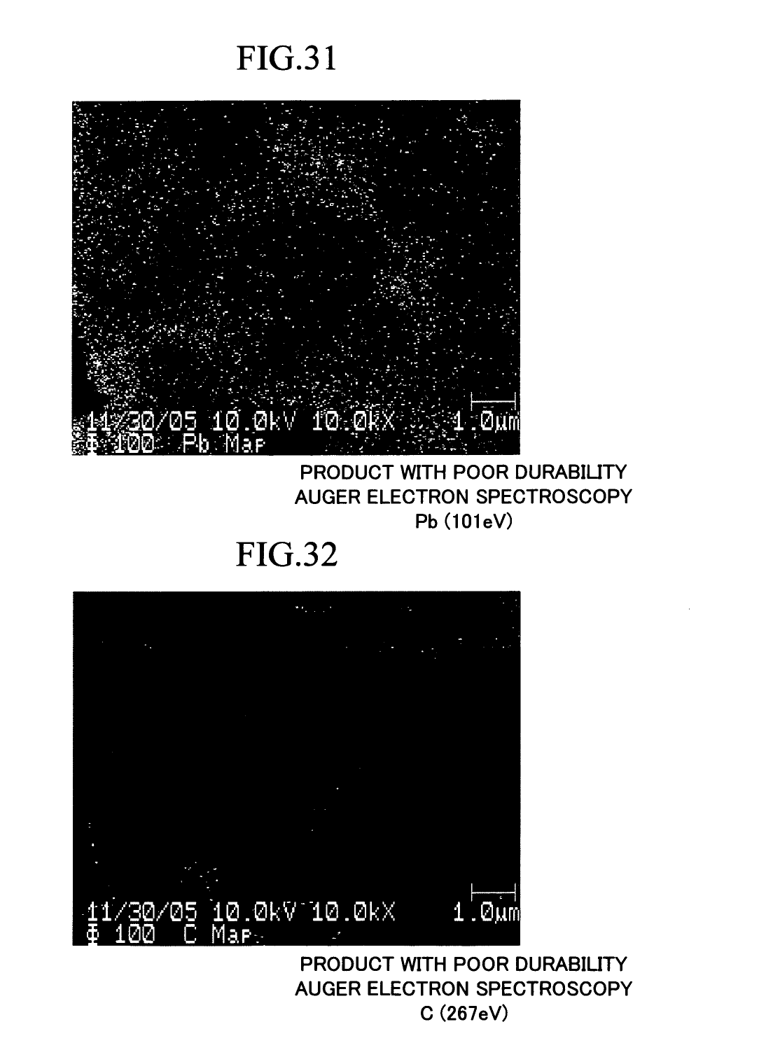

FIG. 29 is a photograph (SEM image) of the surface of the emitter section of the electron-emitting device whose durability is poor, taken by the scanning electron microscope. FIGS. 30, 31, and 32 are photographs showing detection of silicon (Si), lead (Pb), and carbon (C), respectively, on the surface (upper surface) of the emitter section of the electron-emitting device whose durability is poor by Auger electron spectroscopy. In FIGS. 30 to 32, bright regions (white regions) are where object atoms of detection are present.

As is understood from comparison between FIG. 30 and aforementioned FIG. 26, silicon (thus, silicon oxide) is absent on the surface of the emitter section of the electron-emitting device whose durability is poor. That is, the surface of the emitter section of the electron-emitting device whose durability is poor is not covered with a silicon oxide film. It is understood from comparison between FIG. 29 and FIG. 31 that lead is present in a large amount on the surface of the emitter section. Analysis of the surface of the emitter section by the photoelectron spectroscope (XPS, ESCA) has confirmed that metal lead and lead oxide are present, indicating that the surface of the emitter section is partially metalized. Furthermore, it is understood from FIGS. 29, 31, and 32 that carbon is slightly present at top portions (convex portions) of crystal grains of the surface of the emitter section 13. Conceivably, through electron-emitting operations, this carbon has deposited on the upper surface of the emitter section 13.

FIGS. 25 to 32 show the surfaces of the emitter sections of those electron-emitting devices which have undergone the durability test. In this connection, before the durability test, similar analysis was conducted on an electron-emitting device manufactured by the above-described example manufacturing method (an electron-emitting device manufactured by a method similar to that for manufacturing the electron-emitting device appearing in FIGS. 25 to 28). This analysis has confirmed that the emitter section 13 of the electron-emitting device is covered with a silicon oxide film. By contrast, in an electron-emitting device manufactured by a method similar to that for manufacturing the electron-emitting device appearing in FIGS. 29 to 32, it has been confirmed that, before the durability test, the emitter section 13 is not covered with a silicon oxide film.

As described above, in the electron-emitting device 10, the protective film 13b of oxide is formed on the upper surface of the emitter section 13. Accordingly, an upper portion of the emitter section 13 is protected from attack of gas molecules staying in the vicinity of the emitter section 13 and ionized by electron-emitting operations. As a result, since an upper portion of the emitter section 13 is not metalized, even when the number of electron-emitting operations increases, the amount of emitted electrons of the electron-emitting device 10 is unlikely to drop.

Next, an electron-emitting device and a method of manufacturing the same according to a second embodiment of the present invention will be described. The second embodiment differs from the first embodiment only in the protective film 13b of the emitter section. Accordingly, this difference will be described.

The protective film 13b of the first embodiment is not formed on those portions of the upper surface of the emitter section 13 which are in contact with the lower surfaces of the upper electrodes 14. Specifically, the protective film 13b is formed on portions of the upper surface of the emitter section 13 separated from the lower surfaces of the upper electrodes 14 and on portions of the upper surface of the emitter section 13 exposed to the exterior of the upper electrodes 14 through the fine through holes 14a of the upper electrodes 14.

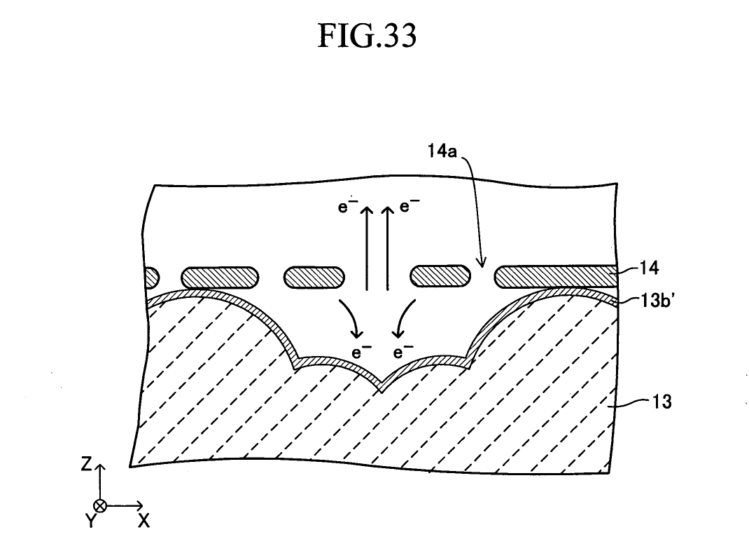

By contrast, as shown in FIG. 33, in the electron-emitting device of the second embodiment, a protective film 13b′ is formed not only on portions of the upper surface of the emitter section 13 separated from the lower surfaces of the upper electrodes 14 and on portions of the upper surface of the emitter section 13 exposed to the exterior of the upper electrodes 14 through the fine through holes 14a of the upper electrodes 14 but also on those portions of the upper surface of the emitter section 13 where the upper surface of the emitter section 13 starts to separate from the lower surfaces of the upper electrodes 14 (in regions sandwiched between the upper surface of the emitter section 13 and the lower surfaces of the upper electrodes 14).

That is, the protective film 13b′ is formed on the entire upper surface of the emitter section 13. In other words, the protective film 13b′ is formed in contact with both of the upper surface of the emitter section 13 and the lower surfaces of the upper electrodes 14 at those portions of the upper surface of the emitter section 13 where the upper surface of the emitter section 13 starts to separate from the lower surfaces of the upper electrodes 14, and is formed in contact with only the upper surface of the emitter section 13 at those portions of the upper surface of the emitter section 13 which are separated from the lower surfaces of the upper electrodes 14.

In contrast to the first embodiment in which the protective film is formed in the course of firing for formation of the upper electrodes 14, in the electron-emitting device of the present embodiment, after firing for formation of the emitter section 13, the protective film 13b′ is formed by a thin-film deposition process such as sputtering; subsequently, the upper electrodes 14 are formed through firing.

Forming the protective film 13b′ through sputtering can provide an oxide having high stability against the aforementioned attack of ions (ion impulse) (an oxide which is unlikely to change upon ion impulse, and stably protects the emitter section). Examples of such an oxide stably exhibiting high protective performance against ion impulse include MgO, CaO, ZnO, MnO, Al₂O₃, Ti₂O₃, BeO, ThO₂, MoO₂, Cr₂O₃, UO₂, HfO₂, ZrO₂, Cu₂O, and CoO. Also, W₁₈O₄₉, Fe₃O₄, SnO₂, GeO₂, BiO₃, NiO, TeO₂, and the like are considered to have the effect of protecting the emitter section 13 from ion impulse.

Those portions of the upper surface of the emitter section 13 where the upper surface of the emitter section starts to separate from the lower surface of the upper electrodes 14 are triple junctions where the emitter section 13, the upper electrodes 14, and a surrounding substance (including vacuum) are in contact with one another. Since an electric field is concentrated on these portions, these portions are important for an operation of supplying electrons from the upper electrodes 14 to the emitter section 13. Accordingly, through protection of these portions of the upper surface of the emitter section 13 by providing the protective film 13b′ thereon as in the case of the present embodiment, there can be provided an electron-emitting device having a character that the amount of emitted electrons is unlikely to drop with the number of electron-emitting operations.

The upper electrodes 14 and/or the emitter section 13 thermally contracts and expands. In the case where the emitter section 13 is formed from a piezoelectric/electrostrictive/antiferroelectric material, application of a drive voltage causes deformation of the emitter section 13. Additionally, Coulomb force associated with an electron-emitting operation is exerted between the upper electrodes 14 and the emitter section 13. Accordingly, in microscopic view, the positions of the above-mentioned triple junctions also vary or move. Therefore, by forming the protective film 13b′ on the entire upper surface of the emitter section 13 as in the case of the present embodiment, even when the positions of the triple junctions vary, the upper surface of the emitter section 13 at the triple junctions can be protected at all times by the protective film 13b′. As a result, there can be provided an electron-emitting device having a character that the amount of emitted electrons is more unlikely to drop with the number of electron-emitting operations.

As described above, the electron-emitting device of the present invention has the protective film on the upper surface of the emitter section 13 and thus can exhibit such excellent performance that, even when the number of electron-emitting operations increases, the amount of emitted electrons is unlikely to drop. Since the fine through holes 14a each having a mean diameter of 10 nm to 100 nm are formed in the upper electrodes 14, more electrons can be emitted efficiently. The present invention is not limited to the above-described embodiments, but may be modified in various other forms without departing from the scope of the invention.

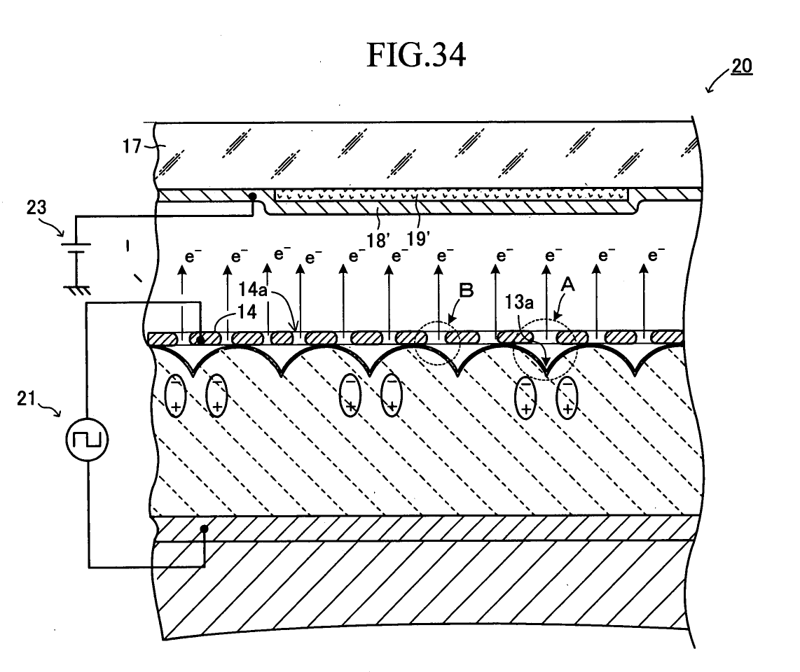

For example, as shown in FIG. 34, an electron-emitting device 20 according to a modified embodiment of the present invention is a modified embodiment of the electron-emitting device 10 in which the collector electrode 18 and the phosphors 19 are replaced with a collector electrode 18′ and phosphors 19′, respectively.

In the electron-emitting device 20, the phosphors 19′ are formed on the lower surface (a surface in opposition to the upper electrodes 14) of the transparent plate 17, and the collector electrode 18′ is formed in such a manner as to cover the phosphors 19′. The collector electrode 18′ has such a thickness as to allow passage therethrough of electrons which are emitted from the emitter section 13 through the fine through holes 14a of the upper electrodes 14. In this case, desirably, the collector electrode 18′ has a thickness of 100 nm or less. The thickness of the collector electrode 18′ can be increased with kinetic energy of emitted electrons.

The above-mentioned configuration is employed by a CRT or the like. The collector electrode 18′ functions as metal backing. Electrons which are emitted from the emitter section 13 through the through holes 14a of the upper electrodes 14 pass through the collector electrode 18′ and impinge on the phosphors 19′. The phosphors 19′ on which electrons impinge are excited and emit light. The electron-emitting device 20 can yield the following effects.
(a) In the case where the phosphors 19′ are not electrically conductive, electrification (negative electrification) of the phosphors 19′ can be avoided. As a result, an electric field for accelerating electrons can be maintained.
(b) Since the collector electrode 18′ reflects light emitted from the phosphors 19′, the light can be efficiently directed toward the transparent plate 17 (toward a light-emitting surface).
(c) Since impingement of excess electrons on the phosphors 19′ can be avoided, deterioration of the phosphors 19′ and generation of gas from the phosphors 19′ can be avoided.

Furthermore, phosphors used in the electron-emitting devices of the above-described embodiments are not limited to a red phosphor, a green phosphor, and a blue phosphor. For example, a white phosphor may be employed. Additionally, the electron-emitting devices of the above-described embodiments are disclosed as displays, each of which includes the focusing electrodes, the collector electrode, the transparent plate, phosphors, and other components. However, these components may not be included. That is, the electron-emitting device according to the present invention may merely be an electron-emitting element which has the emitter section, the upper electrodes, and the lower electrodes and emits electrons. Such an electron-emitting device (electron-emitting element) can be applied to a wide range of devices and apparatus, such as electron irradiation apparatus, light sources, substitutes for LED, electric-component-manufacturing apparatus, and electronic circuit components.

Furthermore, the upper electrodes 14 having finer through holes 14a can be formed from a paste-like organometallic compound which contains three metals (e.g., Pt, Au, and Ir in the weight ratios Pt:Au:Ir=93:4.5:2.5) or two metals (e.g., Pt and Ir in the weight ratio Pt:Ir=97:3).

Additionally, the protective film 13b or 13b′ of the emitter section 13 can be formed by the following methods (1) and (2).
(1) An organometallic compound which contains a component(s) capable of becoming a protective film of the emitter section (e.g., Mg, Ca, Zn, Mn, Al, Ti, Be, Th, Mo, Cr, U, Hf, Zr, Cu, Co, W, Fe, Sn, Ge, Bi, Ni, and Te) is previously added to an organometallic compound which contains a predetermined metal(s) that is to become the upper electrodes. The resultant mixed organometallic compound is applied by printing to an upper portion of the emitter section, followed by heat treatment.
(2) After the upper electrodes are formed, a paste which contains low-melting-point glass particles such as lead borosilicate glass particles is applied by printing to peripheries of the upper electrodes, followed by heat treatment for melting the low-melting-point glass particles. The thus-molten glass penetrates between the upper electrodes and the emitter section by the effect of capillarity. Alternatively, for example, the low-melting-point glass particles may be contained in a material used to form the insulating layer 15. Heat-treating the material for forming the insulating layer 15 causes the glass particles to melt, thereby forming the protective film of the emitter section.

What is claimed is:

1. An electron-emitting device comprising:
an emitter section formed from a dielectric material;
a lower electrode formed on a lower portion of the emitter section; and
an upper electrode formed on an upper portion of the emitter section in opposition to the lower electrode to sandwich the emitter section between the same and the lower electrode, and having a plurality of fine through holes formed therein, lower surfaces of portions of the upper electrode surrounding the fine through holes thereof being separated from and facing the emitter section,
the electron-emitting device emitting electrons from the emitter section through the fine through holes of the upper electrode when a drive voltage is applied between the lower electrode and the upper electrode,
wherein a protective film of oxide is formed on portions of an upper surface of the emitter section separated from the lower surface of the upper electrode and/or on portions of the upper surface of the emitter section exposed to the exterior of the upper electrode through the fine through holes of the upper electrode.

2. An electron-emitting device according to claim 1, wherein the protective film is formed in contact with both of the upper surface of the emitter section and the lower surface of the upper electrode at those portions of the upper surface of the emitter section where the upper surface of the emitter section starts to separate from the lower surface of the upper electrode, and is formed in contact with only the upper surface of the emitter section at those portions of the upper surface of the emitter section which are separated from the lower surface of the upper electrode.

3. An electron-emitting device according to claim 1, wherein the protective film is formed on the entire upper surface of the emitter section.

4. An electron-emitting device according to any one of claim 1, wherein the emitter section is formed from ceramic, and
the protective film is of an oxide which contains atoms that are not replaced with atoms forming a crystallographic structure of the emitter section.

5. An electron-emitting device according to claim 4, wherein the atoms that are not replaced with the atoms forming the crystallographic structure of the emitter section are of silicon (Si).

6. An electron-emitting device according to claim 5, wherein the emitter section is formed from a compound including lead (Pb).

7. A method of manufacturing an electron-emitting device which comprises an emitter section formed from a dielectric material, a lower electrode formed on a lower portion of the emitter section, and an upper electrode formed on an upper portion of the emitter section in opposition to the lower electrode to sandwich the emitter section between the same and the lower electrode, and having a plurality of fine through holes formed therein, lower surfaces of portions of the upper electrode surrounding the fine through holes thereof being separated from and facing the emitter section, the electron-emitting device emitting electrons from the emitter section through the fine through holes of the upper electrode through application of a drive voltage between the lower electrode and the upper electrode, the method comprising the steps of:
adding silicon or a compound containing silicon to a material used to form the emitter section, and firing the material for forming the emitter section; and
forming a protective film of silicon oxide on the upper surface of the emitter section through application of heat to the emitter section in a reducing atmosphere.

8. A method of manufacturing an electron-emitting device according to claim 7, wherein the step of forming the protective film is practiced by applying heat to the emitter section in a state where a pasty and organometallic compound for forming the upper electrode is spread on the upper surface of the emitter section.
